(19) United States
(12) Patent Application Publication
(10) Pub. No.: US 2026/0254507 A1
(43) Pub. Date: Aug. 27, 2026

(54) MULTI-TRANSMISSION OPPORTUNITY SOUNDING SEQUENCES

(71) Applicant: QUALCOMM Incorporated, San Diego, CA (US)

(72) Inventors: Sherief HELWA, San Diego, CA (US); George CHERIAN, San Diego, CA (US); Alfred ASTERJADHI, San Diego, CA (US); Abhishek Pramod PATIL, San Diego, CA (US); Gaurang NAIK, San Diego, CA (US); Giovanni CHISCI, San Diego, CA (US); Sanket Sanjay KALAMKAR, San Diego, CA (US); Sai Yiu Duncan HO, San Diego, CA (US); Ahmed Ragab ELSHERIF, San Jose, CA (US)

(21) Appl. No.: 19/542,640

(22) Filed: Feb. 17, 2026

Related U.S. Application Data
(60) Provisional application No. 63/767,242, filed on Mar. 5, 2025.
(60) Provisional application No. 63/759,609, filed on Feb. 18, 2025.

(51) Int. Cl. H04B 7/06

(52) U.S. Cl. CPC H04B 7/0626; H04B 7/0617

(57) ABSTRACT

This disclosure provides methods, components, devices and systems for multi-transmission opportunity sounding sequences. Some aspects more specifically relate to co-beamforming operations and sounding sequences across multiple transmission opportunities (TXOPs). In some examples, each of a set of access points (APs) may perform in-basic service set (BSS) and cross-BSS channel state information (CSI) collection across multiple TXOPs (e.g., in each TXOP, in-BSS and cross-BSS CSI is collected for all clients of a specific BSS). In some examples, each AP for each BSS may perform cross-BSS CSI collection during a first TXOP, and each AP may perform its own in-BSS CSI collection during other respective TXOPs.

### CROSS REFERENCE

The present Application for Patent claims the benefit of U.S. Provisional Patent Application No. 63/759,609 by HELWA et al., entitled “MULTI-TRANSMISSION OPPORTUNITY SOUNDING SEQUENCES,” filed February 18, 2025, and U.S. Provisional Patent Application No. 63/767,242 by HELWA et al., entitled “MULTI-TRANSMISSION OPPORTUNITY SOUNDING SEQUENCES,” filed March 5, 2025.

### TECHNICAL FIELD

This disclosure relates generally to wireless communication and, more specifically, to multi-transmission opportunity sounding sequences.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular-based protocols (such as 4G, 5G, or 6G). The wireless communication networks may be capable of supporting communication with multiple users by sharing the available system resources (such as time, frequency, and spatial resources). To enable features or provide improved performance, the wireless communication devices may employ technologies such as orthogonal frequency division multiple access (OFDMA), multi-user Multiple-Input Multiple-Output (MU-MIMO), spatial multiplexing, and beamforming. For greater interoperability, the wireless communication networks may support backward compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure that can be implemented in a method for wireless communications by a first access point (AP) is described. The method may include performing, during a first transmission opportunity, a first cross-basic service set (BSS) channel state information (CSI) collection procedure corresponding to at least a first station (STA) served by the first AP and a second AP, the first AP associated with a first BSS and the second AP associated with a second BSS, performing, during the first transmission opportunity after the first cross-BSS CSI collection procedure, an in-BSS CSI collection procedure corresponding to at least the first STA served by the first AP, performing, during the first transmission opportunity, a second cross-BSS CSI collection procedure corresponding to at least a second STA served by the second AP, and performing, during a second transmission opportunity based on failure of at least one of the first cross-BSS CSI collection procedure, the in-BSS CSI collection procedure, or the second cross-BSS CSI collection procedure, a repetition of the first cross-BSS CSI collection procedure, the in-BSS CSI collection procedure, and the second cross-BSS CSI collection procedure, a repetition of only the first cross-BSS CSI collection procedure and the in-BSS CSI collection procedure, or a repetition of only the second cross-BSS CSI collection procedure.

Another innovative aspect of the subject matter described in this disclosure can be implemented in a first AP for wireless communications is described. The first AP may include a processing system that includes processor circuitry and memory circuitry that stores code. The processing system may be configured to cause the first AP to perform, during a first transmission opportunity, a first cross-basic service set (BSS) CSI collection procedure corresponding to at least a first STA served by the first AP and a second AP, the first AP associated with a first BSS and the second AP associated with a second BSS, perform, during the first transmission opportunity after the first cross-BSS CSI collection procedure, an in-BSS CSI collection procedure corresponding to at least the first STA served by the first AP, perform, during the first transmission opportunity, a second cross-BSS CSI collection procedure corresponding to at least a second STA served by the second AP, and perform, during a second transmission opportunity based on failure of at least one of the first cross-BSS CSI collection procedure, the in-BSS CSI collection procedure, or the second cross-BSS CSI collection procedure, a repetition of the first cross-BSS CSI collection procedure, the in-BSS CSI collection procedure, and the second cross-BSS CSI collection procedure, a repetition of only the first cross-BSS CSI collection procedure and the in-BSS CSI collection procedure, or a repetition of only the second cross-BSS CSI collection procedure.

Another innovative aspect of the subject matter described in this disclosure can be implemented in another first AP for wireless communications is described. The first AP may include means for performing, during a first transmission opportunity, a first cross-basic service set (BSS) CSI collection procedure corresponding to at least a first STA served by the first AP and a second AP, the first AP associated with a first BSS and the second AP associated with a second BSS, means for performing, during the first transmission opportunity after the first cross-BSS CSI collection procedure, an in-BSS CSI collection procedure corresponding to at least the first STA served by the first AP, means for performing, during the first transmission opportunity, a second cross-BSS CSI collection procedure corresponding to at least a second STA served by the second AP, and means for performing, during a second transmission opportunity based on failure of at least one of the first cross-BSS CSI collection procedure, the in-BSS CSI collection procedure, or the second cross-BSS CSI collection procedure, a repetition of the first cross-BSS CSI collection procedure, the in-BSS CSI collection procedure, and the second cross-BSS CSI collection procedure, a repetition of only the first cross-BSS CSI collection procedure and the in-BSS CSI collection procedure, or a repetition of only the second cross-BSS CSI collection procedure.

Another innovative aspect of the subject matter described in this disclosure can be implemented in a non-transitory computer-readable medium storing code for wireless communications is described. The code may include instructions executable by one or more processors to perform, during a first transmission opportunity, a first cross-basic service set (BSS) CSI collection procedure corresponding to at least a first STA served by the first AP and a second AP, the first AP associated with a first BSS and the second AP associated with a second BSS, perform, during the first transmission opportunity after the first cross-BSS CSI collection procedure, an in-BSS CSI collection procedure corresponding to at least the first STA served by the first AP, perform, during the first transmission opportunity, a second cross-BSS CSI collection procedure corresponding to at least a second STA served by the second AP, and perform, during a second transmission opportunity based on failure of at least one of the first cross-BSS CSI collection procedure, the in-BSS CSI collection procedure, or the second cross-BSS CSI collection procedure, a repetition of the first cross-BSS CSI collection procedure, the in-BSS CSI collection procedure, and the second cross-BSS CSI collection procedure, a repetition of only the first cross-BSS CSI collection procedure and the in-BSS CSI collection procedure, or a repetition of only the second cross-BSS CSI collection procedure.

In some examples of the method, first access points (APs), and non-transitory computer-readable medium described herein, the repetition of only the first cross-BSS CSI collection procedure and the in-BSS CSI collection procedure may be performed during the second transmission opportunity based on failure of at least one of the first cross-BSS CSI collection procedure or the in-BSS CSI collection procedure during the first transmission opportunity.

In some examples of the method, first access points (APs), and non-transitory computer-readable medium described herein, the repetition of only the second cross-BSS CSI collection procedure may be performed during the second transmission opportunity based on the failure of the second cross-BSS CSI collection procedure during the first transmission opportunity.

Another innovative aspect of the subject matter described in this disclosure can be implemented in a method for wireless communications by a first AP. The method may include transmitting, during a first transmission opportunity, a first sounding invite frame indicative of a first sounding session identifier associated with a first sounding session executed over one or more transmission opportunities, the one or more transmission opportunities including at least the first transmission opportunity, performing, during the first transmission opportunity, one or more first basic service set (BSS) CSI collection procedures based on reception of the first sounding invite frame, communicating, during a second transmission opportunity, a second sounding invite frame indicative of a second sounding session identifier, where the second sounding session identifier is the same as the first sounding session identifier based on the first transmission opportunity and the second transmission opportunity being associated with the first sounding session corresponding to the first sounding session identifier or the second sounding session identifier is different than the first sounding session identifier based on the second transmission opportunity being associated with a second sounding session corresponding to the second sounding session identifier, the second sounding session different than the first sounding session, and performing, during the second transmission opportunity, one or more second BSS CSI collection procedures based on communication of the second sounding invite frame.

Another innovative aspect of the subject matter described in this disclosure can be implemented in a first AP for wireless communications. The first AP may include a processing system that includes processor circuitry and memory circuitry that stores code. The processing system may be configured to cause the first AP to transmit, during a first transmission opportunity, a first sounding invite frame indicative of a first sounding session identifier associated with a first sounding session executed over one or more transmission opportunities, the one or more transmission opportunities including at least the first transmission opportunity, perform, during the first transmission opportunity, one or more first basic service set (BSS) CSI collection procedures based on reception of the first sounding invite frame, communicate, during a second transmission opportunity, a second sounding invite frame indicative of a second sounding session identifier, where the second sounding session identifier is the same as the first sounding session identifier based on the first transmission opportunity and the second transmission opportunity being associated with the first sounding session corresponding to the first sounding session identifier or the second sounding session identifier is different than the first sounding session identifier based on the second transmission opportunity being associated with a second sounding session corresponding to the second sounding session identifier, the second sounding session different than the first sounding session, and perform, during the second transmission opportunity, one or more second BSS CSI collection procedures based on communication of the second sounding invite frame.

Another innovative aspect of the subject matter described in this disclosure can be implemented in another first AP for wireless communications. The first AP may include means for transmitting, during a first transmission opportunity, a first sounding invite frame indicative of a first sounding session identifier associated with a first sounding session executed over one or more transmission opportunities, the one or more transmission opportunities including at least the first transmission opportunity, means for performing, during the first transmission opportunity, one or more first basic service set (BSS) CSI collection procedures based on reception of the first sounding invite frame, means for communicating, during a second transmission opportunity, a second sounding invite frame indicative of a second sounding session identifier, where the second sounding session identifier is the same as the first sounding session identifier based on the first transmission opportunity and the second transmission opportunity being associated with the first sounding session corresponding to the first sounding session identifier or the second sounding session identifier is different than the first sounding session identifier based on the second transmission opportunity being associated with a second sounding session corresponding to the second sounding session identifier, the second sounding session different than the first sounding session, and means for performing, during the second transmission opportunity, one or more second BSS CSI collection procedures based on communication of the second sounding invite frame.

Another innovative aspect of the subject matter described in this disclosure can be implemented in a non-transitory computer-readable medium storing code for wireless communications. The code may include instructions executable by one or more processors to transmit, during a first transmission opportunity, a first sounding invite frame indicative of a first sounding session identifier associated with a first sounding session executed over one or more transmission opportunities, the one or more transmission opportunities including at least the first transmission opportunity, perform, during the first transmission opportunity, one or more first basic service set (BSS) CSI collection procedures based on reception of the first sounding invite frame, communicate, during a second transmission opportunity, a second sounding invite frame indicative of a second sounding session identifier, where the second sounding session identifier is the same as the first sounding session identifier based on the first transmission opportunity and the second transmission opportunity being associated with the first sounding session corresponding to the first sounding session identifier or the second sounding session identifier is different than the first sounding session identifier based on the second transmission opportunity being associated with a second sounding session corresponding to the second sounding session identifier, the second sounding session different than the first sounding session, and perform, during the second transmission opportunity, one or more second BSS CSI collection procedures based on communication of the second sounding invite frame.

Another innovative aspect of the subject matter described in this disclosure can be implemented in a method for wireless communications by a first AP. The method may include performing, during a first transmission opportunity, a first cross-basic service set (BSS) CSI collection procedure corresponding to at least a first STA served by the first AP and a second AP, the first AP associated with a first BSS and the second AP associated with a second BSS, where the first cross-BSS CSI collection procedure includes a set of multiple CSI segments (e.g., portions) and receiving, from the second AP, at least one feedback message based on the first cross-BSS CSI collection procedure.

Another innovative aspect of the subject matter described in this disclosure can be implemented in a first AP for wireless communications. The first AP may include a processing system that includes processor circuitry and memory circuitry that stores code. The processing system may be configured to cause the first AP to perform, during a first transmission opportunity, a first cross-basic service set (BSS) CSI collection procedure corresponding to at least a first STA served by the first AP and a second AP, the first AP associated with a first BSS and the second AP associated with a second BSS, where the first cross-BSS CSI collection procedure includes a set of multiple CSI segments (e.g., portions) and receive, from the second AP, at least one feedback message based on the first cross-BSS CSI collection procedure.

Another innovative aspect of the subject matter described in this disclosure can be implemented in another first AP for wireless communications. The first AP may include means for performing, during a first transmission opportunity, a first cross-basic service set (BSS) CSI collection procedure corresponding to at least a first STA served by the first AP and a second AP, the first AP associated with a first BSS and the second AP associated with a second BSS, where the first cross-BSS CSI collection procedure includes a set of multiple CSI segments (e.g., portions) and means for receiving, from the second AP, at least one feedback message based on the first cross-BSS CSI collection procedure.

Another innovative aspect of the subject matter described in this disclosure can be implemented in a non-transitory computer-readable medium storing code for wireless communications. The code may include instructions executable by one or more processors to perform, during a first transmission opportunity, a first cross-basic service set (BSS) CSI collection procedure corresponding to at least a first STA served by the first AP and a second AP, the first AP associated with a first BSS and the second AP associated with a second BSS, where the first cross-BSS CSI collection procedure includes a set of multiple CSI segments (e.g., portions) and receive, from the second AP, at least one feedback message based on the first cross-BSS CSI collection procedure.

In some examples of the method, first access points (APs), and non-transitory computer-readable medium described herein, the at least one feedback message includes a single feedback message associated with the set of multiple CSI segments (e.g., portions), the single feedback message received after completion of the set of multiple CSI segments.

In some examples of the method, first access points (APs), and non-transitory computer-readable medium described herein, the at least one feedback message includes a respective feedback message associated with each CSI segment (e.g., portion) of the set of multiple CSI segments, each feedback message received after a corresponding CSI segment.

In some examples of the method, first access points (APs), and non-transitory computer-readable medium described herein, the at least one feedback message may be received during the first transmission opportunity.

In some examples of the method, first access points (APs), and non-transitory computer-readable medium described herein, the at least one feedback message includes a single feedback message received during a second transmission opportunity subsequent to the first transmission opportunity.

Another innovative aspect of the subject matter described in this disclosure can be implemented in a method for wireless communications by a first AP. The method may include one or more memories storing processor-executable code, one or more processors coupling with the one or more memories and individually or collectively operable to execute the code to cause the first AP to, performing, during a first transmission opportunity, a first cross-basic service set (BSS) channel state information (CSI) collection procedure corresponding to at least a first station (STA) served by the first AP and a second AP, the first AP associated with a first BSS and the second AP associated with a second BSS, performing, during the first transmission opportunity and after the first cross-BSS CSI collection procedure, an in-BSS CSI collection procedure corresponding to at least the first STA served by the first AP, and performing, during the first transmission opportunity or during a second transmission opportunity in accordance with information exchanged via a first initial handshake procedure between the first AP and the second AP, a second cross-BSS CSI collection procedure corresponding to at least a second STA served by the second AP.

Another innovative aspect of the subject matter described in this disclosure can be implemented in a first AP for wireless communications. The first AP may include a processing system that includes processor circuitry and memory circuitry that stores code. The processing system may be configured to cause the first AP to one or more memories storing processor-executable code, one or more processors coupled with the one or more memories and individually or collectively operable to execute the code to cause the first AP to, perform, during a first transmission opportunity, a first cross-basic service set (BSS) CSI collection procedure corresponding to at least a first STA served by the first AP and a second AP, the first AP associated with a first BSS and the second AP associated with a second BSS, perform, during the first transmission opportunity and after the first cross-BSS CSI collection procedure, an in-BSS CSI collection procedure corresponding to at least the first STA served by the first AP, and perform, during the first transmission opportunity or during a second transmission opportunity in accordance with information exchanged via a first initial handshake procedure between the first AP and the second AP, a second cross-BSS CSI collection procedure corresponding to at least a second STA served by the second AP.

Another innovative aspect of the subject matter described in this disclosure can be implemented in a first AP for wireless communications. The first AP may include means for one or more memories storing processor-executable code, means for one or more processors coupling with the one or more memories and individually or collectively operable to execute the code to cause the first AP to, means for performing, during a first transmission opportunity, a first cross-basic service set (BSS) CSI collection procedure corresponding to at least a first STA served by the first AP and a second AP, the first AP associated with a first BSS and the second AP associated with a second BSS, means for performing, during the first transmission opportunity and after the first cross-BSS CSI collection procedure, an in-BSS CSI collection procedure corresponding to at least the first STA served by the first AP, and means for performing, during the first transmission opportunity or during a second transmission opportunity in accordance with information exchanged via a first initial handshake procedure between the first AP and the second AP, a second cross-BSS CSI collection procedure corresponding to at least a second STA served by the second AP.

Another innovative aspect of the subject matter described in this disclosure can be implemented in a non-transitory computer-readable medium storing code for wireless communications is described. The code may include instructions executable by one or more processors to one or more memories storing processor-executable code, one or more processors coupled with the one or more memories and individually or collectively operable to execute the code to cause the first AP to, perform, during a first transmission opportunity, a first cross-basic service set (BSS) CSI collection procedure corresponding to at least a first STA served by the first AP and a second AP, the first AP associated with a first BSS and the second AP associated with a second BSS, perform, during the first transmission opportunity and after the first cross-BSS CSI collection procedure, an in-BSS CSI collection procedure corresponding to at least the first STA served by the first AP, and perform, during the first transmission opportunity or during a second transmission opportunity in accordance with information exchanged via a first initial handshake procedure between the first AP and the second AP, a second cross-BSS CSI collection procedure corresponding to at least a second STA served by the second AP.

Some examples of the method, first APs, and non-transitory computer-readable medium described herein may further include operations, features, means, or instructions for detecting a failure of the in-BSS CSI collection procedure and reinitiate the in-BSS CSI collection procedure based on the detecting.

Some examples of the method, first APs, and non-transitory computer-readable medium described herein may further include operations, features, means, or instructions for refraining from performing a second initial handshake procedure with the second AP after detecting a failure of the in-BSS CSI collection procedure and prior to reinitiating the in-BSS CSI collection procedure.

Another innovative aspect of the subject matter described in this disclosure can be implemented in a method for wireless communications by a first AP. The method may include one or more memories storing processor-executable code, one or more processors coupling with the one or more memories and individually or collectively operable to execute the code to cause the first AP to, performing, during a first transmission opportunity, a first cross-basic service set (BSS) CSI collection procedure corresponding to at least a first STA served by the first AP and a second AP, the first AP associated with a first BSS and the second AP associated with a second BSS, performing, during the first transmission opportunity, a second cross-BSS CSI collection procedure corresponding to at least a second STA served by the second AP, and performing, during a second transmission opportunity, an in-BSS CSI collection procedure corresponding to at least the first STA.

Another innovative aspect of the subject matter described in this disclosure can be implemented in a first AP for wireless communications. The first AP may include a processing system that includes processor circuitry and memory circuitry that stores code. The processing system may be configured to cause the first AP to one or more memories storing processor-executable code, one or more processors coupled with the one or more memories and individually or collectively operable to execute the code to cause the first AP to, perform, during a first transmission opportunity, a first cross-basic service set (BSS) CSI collection procedure corresponding to at least a first STA served by the first AP and a second AP, the first AP associated with a first BSS and the second AP associated with a second BSS, perform, during the first transmission opportunity, a second cross-BSS CSI collection procedure corresponding to at least a second STA served by the second AP, and perform, during a second transmission opportunity, an in-BSS CSI collection procedure corresponding to at least the first STA.

Another innovative aspect of the subject matter described in this disclosure can be implemented in a first AP for wireless communications. The first AP may include means for one or more memories storing processor-executable code, means for one or more processors coupling with the one or more memories and individually or collectively operable to execute the code to cause the first AP to, means for performing, during a first transmission opportunity, a first cross-basic service set (BSS) CSI collection procedure corresponding to at least a first STA served by the first AP and a second AP, the first AP associated with a first BSS and the second AP associated with a second BSS, means for performing, during the first transmission opportunity, a second cross-BSS CSI collection procedure corresponding to at least a second STA served by the second AP, and means for performing, during a second transmission opportunity, an in-BSS CSI collection procedure corresponding to at least the first STA.

Another innovative aspect of the subject matter described in this disclosure can be implemented in a non-transitory computer-readable medium storing code for wireless communications is described. The code may include instructions executable by one or more processors to one or more memories storing processor-executable code, one or more processors coupled with the one or more memories and individually or collectively operable to execute the code to cause the first AP to, perform, during a first transmission opportunity, a first cross-basic service set (BSS) CSI collection procedure corresponding to at least a first STA served by the first AP and a second AP, the first AP associated with a first BSS and the second AP associated with a second BSS, perform, during the first transmission opportunity, a second cross-BSS CSI collection procedure corresponding to at least a second STA served by the second AP, and perform, during a second transmission opportunity, an in-BSS CSI collection procedure corresponding to at least the first STA.

In some examples of the method, first APs, and non-transitory computer-readable medium described herein, performing the first cross-BSS CSI collection procedure may include operations, features, means, or instructions for performing a first handshake procedure with the second AP and a second handshake procedure with the first STA, transmit a null data packet announcement (NDPA) frame that triggers a null data packet (NDP) frame by the second AP, transmit, after the NDP frame may be transmitted by the second AP, a beamforming report poll (BFRP) frame, and receive a CSI report message from the first STA in accordance with the BFRP frame.

In some examples of the method, first APs, and non-transitory computer-readable medium described herein, performing the second cross-BSS CSI collection procedure may include operations, features, means, or instructions for detecting, in accordance with a previous handshake procedure with the second AP, a null data packet announcement (NDPA) frame from the second AP that triggers a null data packet (NDP) frame by the first AP, transmit the NDP frame in accordance with the NDPA frame, and receive a CSI report message from the second STA in response to a beamforming report poll (BFRP) frame from the second AP and in accordance with the NDP frame.

Another innovative aspect of the subject matter described in this disclosure can be implemented in a method for wireless communications by a first AP. The method may include one or more memories storing processor-executable code, one or more processors coupling with the one or more memories and individually or collectively operable to execute the code to cause the first AP to, performing, during a first transmission opportunity, a first cross-basic service set (BSS) CSI collection procedure corresponding to at least a first STA served by the first AP and a second AP, the first AP associated with a first BSS and the second AP associated with a second BSS, where the first cross-BSS CSI collection procedure includes a set of multiple CSI portions, and receiving, from the second AP, at least one feedback message based on the first cross-BSS CSI collection procedure.

Another innovative aspect of the subject matter described in this disclosure can be implemented in a first AP for wireless communications. The first AP may include a processing system that includes processor circuitry and memory circuitry that stores code. The processing system may be configured to cause the first AP to one or more memories storing processor-executable code, one or more processors coupled with the one or more memories and individually or collectively operable to execute the code to cause the first AP to, perform, during a first transmission opportunity, a first cross-basic service set (BSS) CSI collection procedure corresponding to at least a first STA served by the first AP and a second AP, the first AP associated with a first BSS and the second AP associated with a second BSS, where the first cross-BSS CSI collection procedure includes a set of multiple CSI portions, and receive, from the second AP, at least one feedback message based on the first cross-BSS CSI collection procedure.

Another innovative aspect of the subject matter described in this disclosure can be implemented in a first AP for wireless communications. The first AP may include means for one or more memories storing processor-executable code, means for one or more processors coupling with the one or more memories and individually or collectively operable to execute the code to cause the first AP to, means for performing, during a first transmission opportunity, a first cross-basic service set (BSS) CSI collection procedure corresponding to at least a first STA served by the first AP and a second AP, the first AP associated with a first BSS and the second AP associated with a second BSS, where the first cross-BSS CSI collection procedure includes a set of multiple CSI portions, and means for receiving, from the second AP, at least one feedback message based on the first cross-BSS CSI collection procedure.

Another innovative aspect of the subject matter described in this disclosure can be implemented in a non-transitory computer-readable medium storing code for wireless communications is described. The code may include instructions executable by one or more processors to one or more memories storing processor-executable code, one or more processors coupled with the one or more memories and individually or collectively operable to execute the code to cause the first AP to, perform, during a first transmission opportunity, a first cross-basic service set (BSS) CSI collection procedure corresponding to at least a first STA served by the first AP and a second AP, the first AP associated with a first BSS and the second AP associated with a second BSS, where the first cross-BSS CSI collection procedure includes a set of multiple CSI portions, and receive, from the second AP, at least one feedback message based on the first cross-BSS CSI collection procedure.

In some examples of the method, first APs, and non-transitory computer-readable medium described herein, the at least one feedback message includes a single feedback message associated with the set of multiple CSI portions, the single feedback message received after completion of the set of multiple CSI portions.

In some examples of the method, first APs, and non-transitory computer-readable medium described herein, the at least one feedback message includes a respective feedback message associated with each CSI portion of the set of multiple CSI portions, each feedback message received after a corresponding CSI portion.

In some examples of the method, first APs, and non-transitory computer-readable medium described herein, the at least one feedback message may be received during the first transmission opportunity.

Another innovative aspect of the subject matter described in this disclosure can be implemented in a method for wireless communications by a first AP. The method may include one or more memories storing processor-executable code, one or more processors coupling with the one or more memories and individually or collectively operable to execute the code to cause the first AP to, transmitting, during a first transmission opportunity, a first sounding invite frame associated with a first sounding session executed over one or more transmission opportunities, the one or more transmission opportunities including at least the first transmission opportunity, performing, during the first transmission opportunity, one or more first basic service set (BSS) CSI collection procedures based on reception of the first sounding invite frame, communicating, during a second transmission opportunity, a second sounding invite frame, where the second sounding invite frame is associated with the first sounding session based on the first transmission opportunity and the second transmission opportunity being associated with the first sounding session or the second sounding invite frame is associated with a second sounding session based on the second transmission opportunity being associated with the second sounding session, the second sounding session different than the first sounding session, and performing, during the second transmission opportunity, one or more second BSS CSI collection procedures based on communication of the second sounding invite frame.

Another innovative aspect of the subject matter described in this disclosure can be implemented in a first AP for wireless communications. The first AP may include a processing system that includes processor circuitry and memory circuitry that stores code. The processing system may be configured to cause the first AP to one or more memories storing processor-executable code, one or more processors coupled with the one or more memories and individually or collectively operable to execute the code to cause the first AP to, transmit, during a first transmission opportunity, a first sounding invite frame associated with a first sounding session executed over one or more transmission opportunities, the one or more transmission opportunities including at least the first transmission opportunity, perform, during the first transmission opportunity, one or more first basic service set (BSS) CSI collection procedures based on reception of the first sounding invite frame, communicate, during a second transmission opportunity, a second sounding invite frame, where the second sounding invite frame is associated with the first sounding session based on the first transmission opportunity and the second transmission opportunity being associated with the first sounding session or the second sounding invite frame is associated with a second sounding session based on the second transmission opportunity being associated with the second sounding session, the second sounding session different than the first sounding session, and perform, during the second transmission opportunity, one or more second BSS CSI collection procedures based on communication of the second sounding invite frame.

Another innovative aspect of the subject matter described in this disclosure can be implemented in a first AP for wireless communications. The first AP may include means for one or more memories storing processor-executable code, means for one or more processors coupling with the one or more memories and individually or collectively operable to execute the code to cause the first AP to, means for transmitting, during a first transmission opportunity, a first sounding invite frame associated with a first sounding session executed over one or more transmission opportunities, the one or more transmission opportunities including at least the first transmission opportunity, means for performing, during the first transmission opportunity, one or more first basic service set (BSS) CSI collection procedures based on reception of the first sounding invite frame, means for communicating, during a second transmission opportunity, a second sounding invite frame, where the second sounding invite frame is associated with the first sounding session based on the first transmission opportunity and the second transmission opportunity being associated with the first sounding session or the second sounding invite frame is associated with a second sounding session based on the second transmission opportunity being associated with the second sounding session, the second sounding session different than the first sounding session, and means for performing, during the second transmission opportunity, one or more second BSS CSI collection procedures based on communication of the second sounding invite frame.

Another innovative aspect of the subject matter described in this disclosure can be implemented in a non-transitory computer-readable medium storing code for wireless communications is described. The code may include instructions executable by one or more processors to one or more memories storing processor-executable code, one or more processors coupled with the one or more memories and individually or collectively operable to execute the code to cause the first AP to, transmit, during a first transmission opportunity, a first sounding invite frame associated with a first sounding session executed over one or more transmission opportunities, the one or more transmission opportunities including at least the first transmission opportunity, perform, during the first transmission opportunity, one or more first basic service set (BSS) CSI collection procedures based on reception of the first sounding invite frame, communicate, during a second transmission opportunity, a second sounding invite frame, where the second sounding invite frame is associated with the first sounding session based on the first transmission opportunity and the second transmission opportunity being associated with the first sounding session or the second sounding invite frame is associated with a second sounding session based on the second transmission opportunity being associated with the second sounding session, the second sounding session different than the first sounding session, and perform, during the second transmission opportunity, one or more second BSS CSI collection procedures based on communication of the second sounding invite frame.

In some examples of the method, first APs, and non-transitory computer-readable medium described herein, in an event of a retransmission of at least a portion of the first sounding session, the retransmission may be associated with the first sounding session based on the first sounding invite frame.

Some examples of the method, first APs, and non-transitory computer-readable medium described herein may further include operations, features, means, or instructions for tracking a coherence time associated with the one or more first BSS CSI collection procedures based on the first sounding session, transmit, based on determining that information collected via the one or more first BSS CSI collection procedures may be outdated, a third sounding invite frame associated with a third sounding session, and perform, during the third sounding session, one or more third BSS CSI collection procedures based on transmission of the third sounding invite frame.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a pictorial diagram of another example wireless communication network.

FIG. 5 shows an example of a sounding sequence scheme that supports multi-transmission opportunity sounding sequences.

FIG. 6 shows an example of a sounding sequence scheme that supports multi-transmission opportunity sounding sequences.

FIG. 7 shows an example of a sounding sequence scheme that supports multi-transmission opportunity sounding sequences.

FIG. 8 shows an example of a sounding sequence scheme that supports multi-transmission opportunity sounding sequences.

FIG. 9 shows an example of a sounding sequence scheme that supports multi-transmission opportunity sounding sequences.

FIGS. 10A and 10B show examples of sounding sequence schemes that support multi-transmission opportunity sounding sequences.

FIG. 11 shows a block diagram of an example wireless communication device that supports multi-transmission opportunity sounding sequences.

FIGS. 12 through 14 show flowcharts illustrating example processes performable by or at a first access point (AP) that supports multi-transmission opportunity sounding sequences.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Some wireless communication networks may support Co-beamforming (CoBF) operations. CoBF operations may refer to coordinated AP schemes that simultaneously utilize the medium in multiple (e.g., two) basic service sets (BSSs) to improve system throughput. CoBF operations may exploit hardware capabilities of multiple APs (e.g., of multiple BSSs), resulting in larger antenna arrays, to actively nullify signals at other BSS (OBSS) clients by using transmission beamforming. Thus, OBSS interference may be limited, and successful reception at one or more served stations (STAs) may be achieved. However, successful CoBF operations rely on channel state information (CSI). That is, for two APs to successfully perform CoBF operations, both APs may rely on access to a channel estimation (e.g., CSI information) corresponding to a channel response between an AP and clients served by the AP, and a channel estimation (e.g., CSI information) corresponding to a channel response between the AP and clients served by the other AP (e.g., a first AP may rely on CSI from in-BSS STAs served by the first AP, and CSI from OBSS STAs served by the second AP by impacted by transmissions from the first AP). The CoBF operation may include at least two phases: a channel sounding phase and a transmission phase. During the channel sounding phase, CSI information may be made available to the BSS AP and the OBSS AP, so that the CSI information can be used by the OBSS AP to actively null transmitted signals at the OBSS client. During the transmission phase, the two or more contributing APs may coordinate on which clients will be served and may synchronize with each other to perform the simultaneous data transmission.

In some examples, the channel sounding phase may include a sequential sounding. A first AP may perform an initial handshake procedure with a second AP, and an additional handshake procedure with at least one STA served by the first AP. The first AP may then perform in-BSS CSI collection and may support cross-BSS CSI collection by the other AP (e.g., for a first STA served by the first AP). Subsequently (e.g., during a same transmission opportunity (TXOP) and relying on the previously performed handshake procedure with the second AP), the second AP may perform a handshake procedure with a STA served by the second AP and perform in-BSS CSI collection and support cross-BSS CSI collection by the first AP. In a joint channel sounding phase, the sounding process may be performed more efficiently such that CSI estimation is performed by both APs simultaneously (e.g., in-BSS CSI and cross-BSS CSI collection may be performed simultaneously during a single TXOP).

In some cases, sounding sequences may be prone to error (e.g., due to the length of the sounding sequence, whether sequential or joint sounding procedures are utilized). In the case of such errors, the entirety of the sequences (e.g., including handshake procedures and both in-BSS and cross-BSS CSI collection) may be repeated to successfully complete the sounding procedure and support the CoBF operations. Additionally, or alternatively, in some cases, the STA served by one AP may not be available at the time when another AP initiates the sounding sequences, further increasing the likelihood of errors or sounding failure. Such repeated sequences due to errors may result in increased system latency, increased signaling overhead, increased delays, and poor user experience.

Various aspects relate generally to sounding sequences to support CoBF operations. Some aspects more specifically relate to CSI collection and sounding sequences after failure of a single TXOP. In some examples, the sounding sequence may be performed (e.g., by at least two APs) across a single TXOP, where the single TXOP is associated with performing cross-BSS CSI collection prior to in-BSS CSI collection for each BSS. In such examples, during the single TXOP the first AP (e.g., served by a first STA) may perform a sounding sequence which may include performing a handshake procedure with the second AP (e.g., served by a second STA) and performing a handshake with at least the first STA, and then performing first cross-BSS CSI collection for the first AP followed by first in-BSS CSI collection for the first AP followed by second cross-BSS CSI collection for the second AP followed by second in-BSS CSI collection for the second AP. In some examples, in the case of an error in at least part of the sounding sequence, the first AP and the second AP may reperform, in a second TXOP, the entire sounding sequence. In some other examples, in the case of an error in the first cross-BSS CSI collection or the first in-BSS CSI collection, the first AP and the second AP may reperform, in the second TXOP, a first part (e.g., only a first part) of the sounding sequence including the first cross-BSS CSI collection procedure and the first in-BSS CSI collection procedure. Conversely, in the case of an error in the second cross-BSS CSI collection procedure or the second in-BSS CSI collection procedure, the first AP and the second AP may reperform, in the second TXOP, a second part (e.g., only a second part) of the sounding sequence including the second cross-BSS CSI collection procedure and the second in-BSS CSI collection procedure (e.g., retry half the sounding sequence rather than the entire sounding sequence).

Additionally, some aspects more specifically relate to session identifiers (IDs) for CSI collection and sounding sequences. In some examples, the first AP may generate a session ID for a sounding session and may transmit, via a first sounding invite frame of a first TXOP in the sounding session, an indication of the session ID. The first AP may additionally include an indication of the session ID in respective sounding invite frames of one or more additional TXOPs associated with the same sounding session. For example, the first AP may transmit an indication of the session ID via a second sounding invite frame of a second TXOP based on the second TXOP being associated with the same sounding session as the first TXOP.

Additionally, some aspects more specifically relate to feedback for CSI collection and sounding sequences. In some examples, the second AP may transmit at least one feedback message in response to cross-BSS CSI collection by the first AP, where the cross-BSS CSI collection includes multiple CSI segments (e.g., portions). In some cases, the second AP may transmit, in a same TXOP as the cross-BSS CSI collection, a single feedback message in response to the multiple CSI segments (e.g., portions). In such cases, the single feedback message may include a bitmap that indicates whether each of the CSI segments (e.g., portions) was successful or unsuccessful received. Alternatively, the second AP may transmit, in the same TXOP as the cross-BSS CSI collection, a respective feedback message in response to each CSI segment (e.g., after completion of the CSI segment or the CSI portion). Additionally, or alternatively, the second AP may transmit, in a second TXOP, a single feedback message associated with the cross-BSS CSI collection in a first TXOP, where the second TXOP is subsequent to the first TXOP.

Particular aspects of the subject matter described in this disclosure can be implemented to realize one or more of the following potential advantages. In some examples, by performing cross-BSS CSI collection prior to in-BSS CSI collection (e.g., within a given TXOP), repeated in-BSS CSI collection may be performed in the case of error without the additional signaling overhead of repeated handshake procedures across APs. Additionally, by reperforming only part of a sounding sequence after failure of the part of the sounding sequence, the described techniques can be used to decrease the latency of repeated sounding sequences in the case of errors. Additionally, or alternatively, in some examples, by including a session ID in respective sounding invite frames of TXOPs belonging to a same sounding session, a sounding sequence may be split over multiple TXOPs and retransmissions of part of or all of a sounding sequence (e.g., when an error occurs) may be linked to a corresponding sounding session. Additionally, or alternatively, by transmitting at least one feedback message in response to failure of at least one CSI segment (e.g., portion) associated with cross-BSS CSI collection, repeated cross-BSS CSI collection may be performed in the case of error without repeating in-BSS CSI collection, a subset of CSI segments (e.g., portions) associated with the cross-BSS CSI collection may be repeated instead of all CSI segments (e.g., portions) associated with the cross-BSS CSI collection when an error occurs, or both.

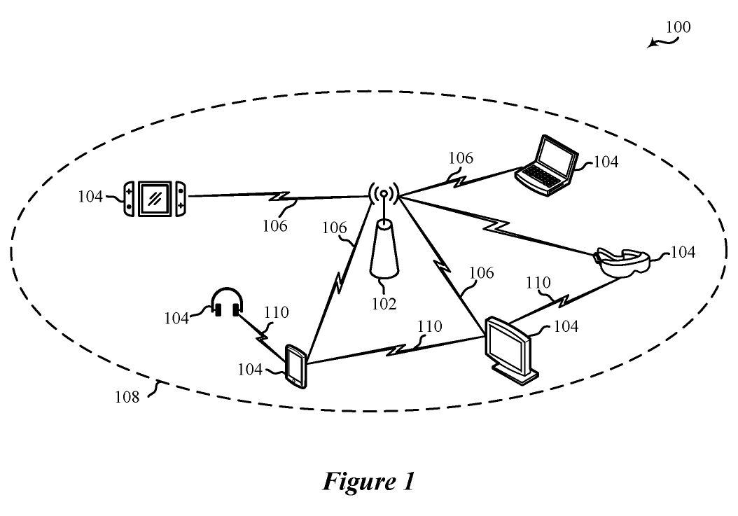

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network’s core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs102 and STAs104 described herein also may communicate in other frequency bands that may support licensed or unlicensed communications. For example, the APs102 or STAs104, or both, also may be capable of communicating over licensed operating bands, where multiple operators may have respective licenses to operate in the same or overlapping frequency ranges. Such licensed operating bands may map to or be associated with frequency range designations of FR1 (410 MHz – 7.125 GHz), FR2 (24.25 GHz – 52.6 GHz), FR3 (7.125 GHz – 24.25 GHz), FR4a or FR4–1 (52.6 GHz – 71 GHz), FR4 (52.6 GHz – 114.25 GHz), and FR5 (114.25 GHz – 300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4x80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160 + 80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate subchannel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some wireless communication systems, wireless communication devices (such as an AP 102 and STAs 104 described with reference to FIG. 1) may operate via one or more wireless communication links in a frequency band higher than a sub-7 GHz (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (for example, a frequency band between 30 GHz and 300 GHz, such as a 60 GHz frequency band). A wireless communication system supporting such mmWave communications (such as AP 102 and STAs 104 in wireless communications network 100) may use integrated mmWave (IMMW) techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs102 and STAs104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs102 and STAs104 to support mmWave operation.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QoS) parameters. For example, existing technology (such as IEEE 802.11ax standard amendment protocols) supports the use of up to 1024-quadrature amplitude modulation (QAM), where a modulated symbol carries 10 bits. To further improve peak data rate, each of the AP 102 or the STA 104 may employ use of 4096-QAM (also referred to as “4k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream * 996*4 subcarriers * 8 spatial streams / 13.6 µs per OFDM symbol). The AP 102 or the STA 104 using 4096-QAM may enable a 20% increase in data rate compared to 1024-QAM given the same coding rate, thereby allowing users to obtain higher transmission efficiency.

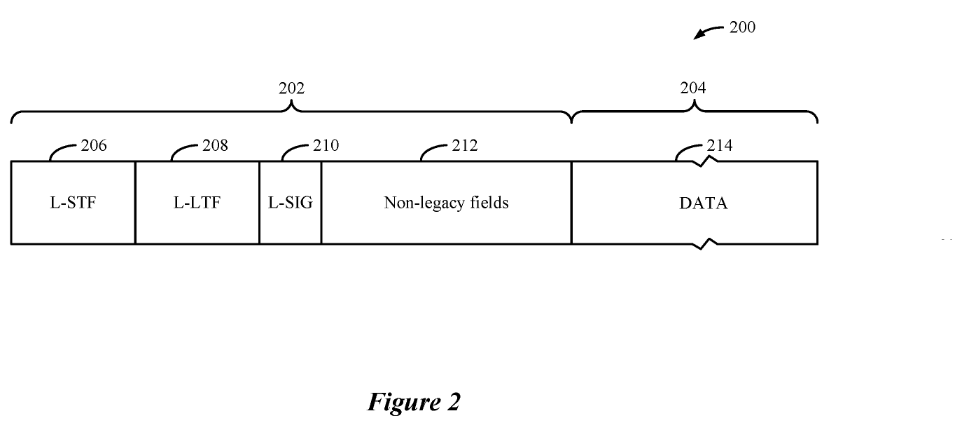

FIG. 2 shows an example protocol data unit (PDU) 200 usable for wireless communication between a wireless AP and one or more wireless STAs. For example, the AP and STAs may be examples of the AP 102 and the STAs104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

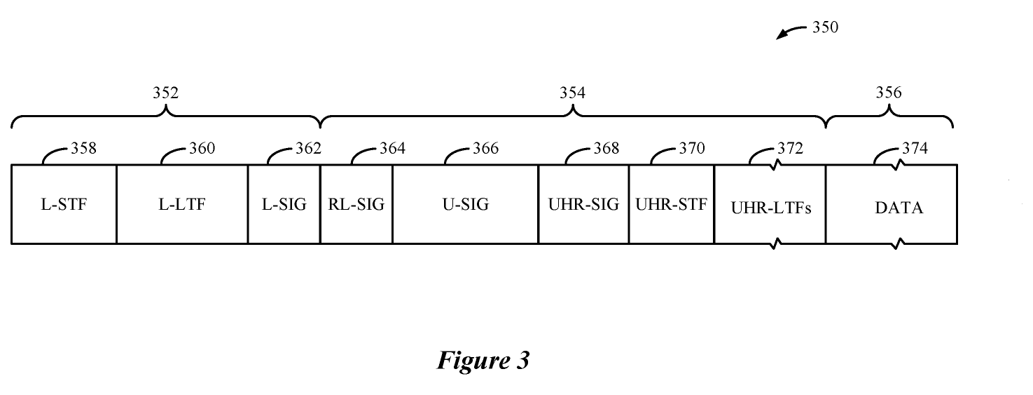

FIG. 3 shows an example physical layer (PHY) protocol data unit (PPDU) 350 usable for communications between a wireless AP and one or more wireless STAs. For example, the AP and STAs may be examples of the AP 102 and the STAs104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

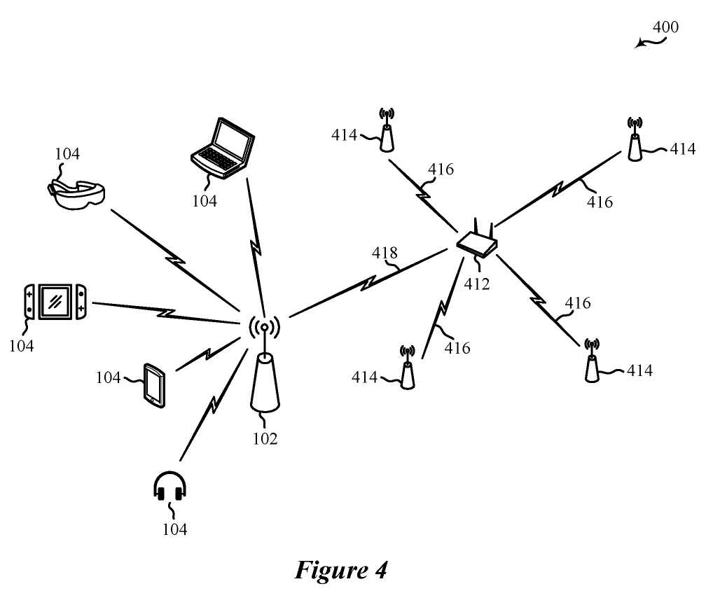

FIG. 4 shows a pictorial diagram of another example wireless communication network 400. According to some aspects, the wireless communication network 400 can be an example of a mesh network, an IoT network, or a sensor network in accordance with one or more of the IEEE 802.11 family of wireless communication protocol standards (including the 802.11ah amendment). The wireless communication network 400 may include multiple wireless communication devices 414, which in some implementations may include APs102, STAs104, or both. The wireless communication devices 414 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 414 sense, measure, collect or otherwise obtain and process data and transmit such raw or processed data to an intermediate device 412 for subsequent processing or distribution. Additionally, or alternatively, the intermediate device 412 may transmit control information, digital content (for example, audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a WLAN or a wireless (for example, cellular) wide area network (WWAN), which may, in turn, provide access to external networks including the Internet. For example, the intermediate device 412 may associate and communicate, over a Wi-Fi link 418, with an AP 102 of a wireless communication network 400, which also may serve various STAs 104. In some examples, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

Aspects of transmissions may vary according to a distance between a transmitter (for example, an AP 102 or a STA 104) and a receiver (for example, another AP 102 or STA 104). Wireless communication devices (such as the AP 102 or the STA 104) may generally benefit from having information regarding the location or proximities of the various STAs104 within the coverage area. In some examples, relevant distances may be determined (for example, calculated or computed) using RTT-based ranging procedures. Additionally, in some examples, APs 102 and STAs104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

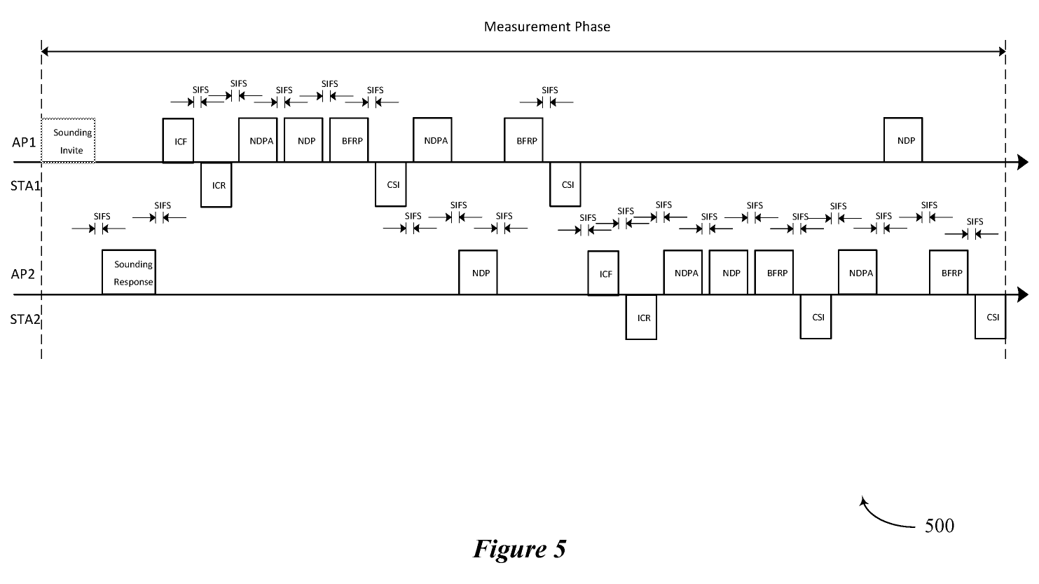

FIG. 5 shows an example of a sounding sequence scheme 500 that supports transmission opportunity sounding sequences. The sounding sequence scheme 500 may implement, or be implemented by, aspects of the FIGS. 1 through 4. For example, an AP1, a STA1, an AP2, and a STA2 may be examples of corresponding devices described with reference to FIGS. 1 through 4.

In some examples, the AP1 and the AP2 may perform channel sounding (e.g., a collaborative process done by two (or more) APs to collect CSI info between each AP and the OBSS clients). CoBF channel sounding may include a sequence including a null data packet announcement (NDPA) frame, a null data packet (NDP) frame, a beamforming report poll (BFRP) frame, and a CSI report frame. An NDPA frame may announce the NDP frame, the BFRP frame may trigger the CSI report frame based on measurements taken on the NDP frame.

In some examples, the AP1 and the AP2 may perform sequential sounding. In-BSS CSI collection may include sounding done for an associated AP by transmitting the NDP and receiving the CSI report in response to the BFRP frame. Cross-BSS CSI collection may include sounding done for OBSS APs. The associated AP may send an NDPA frame on behalf of the OBSS AP. The OBSS AP may send the NDP followed by the BFRP frame sent by the associated AP on behalf of the OBSS AP. The client then reports back its measured CSI. Finally, the OBSS AP decodes the reported CSI frame and stores the needed CSI. The whole process is then repeated for all APs participating in the channel sounding procedure.

To perform the cross-BSS CSI collection, the AP1 may perform a handshake procedure with the AP2. The handshake between APs may include a sounding invite frame and a sounding response frame exchange to ensure the availability (e.g., and willingness) of the other AP to participate in the sounding sequence. Additionally, the handshake between APs may include indications about whether each of the APs will include an ICF/ICR frame exchange with its associated STAs or not, how many associated STAs will be included in the sounding sequence, whether In-BSS sounding is needed before CoBF data transmission or not, and any other information that may be needed for successful CoBF sounding and data transmission. To perform cross-BSS sounding and in-BSS sounding, an AP may perform a handshake procedure with the STA served by the AP (e.g., an initial control frame (ICF) frame and initial control response (ICR) frame exchange) to ensure the availability of the STA to participate in the sounding sequence.

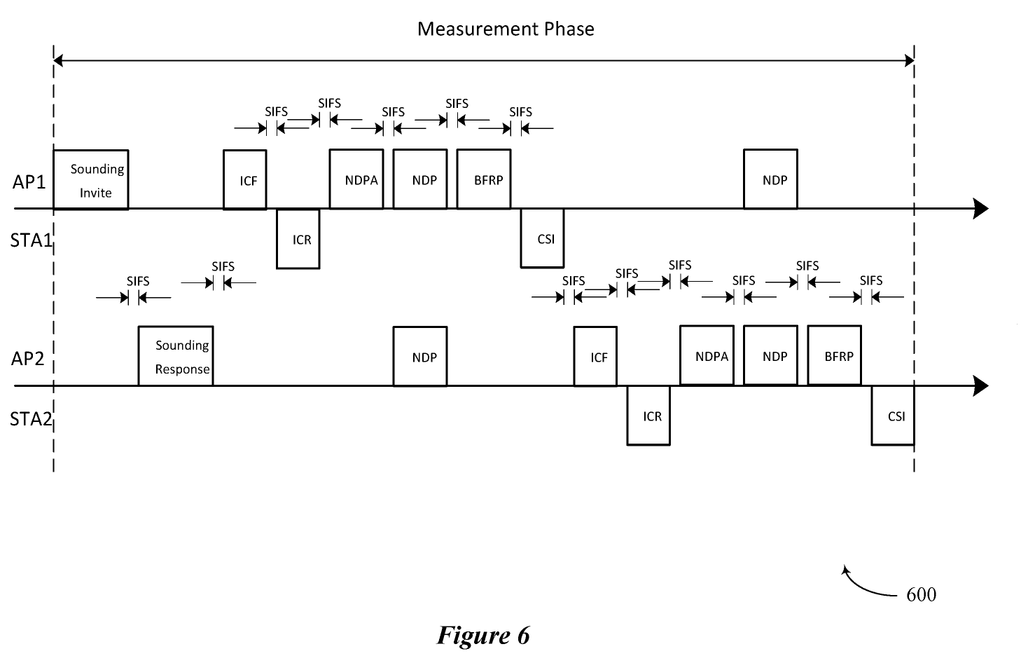

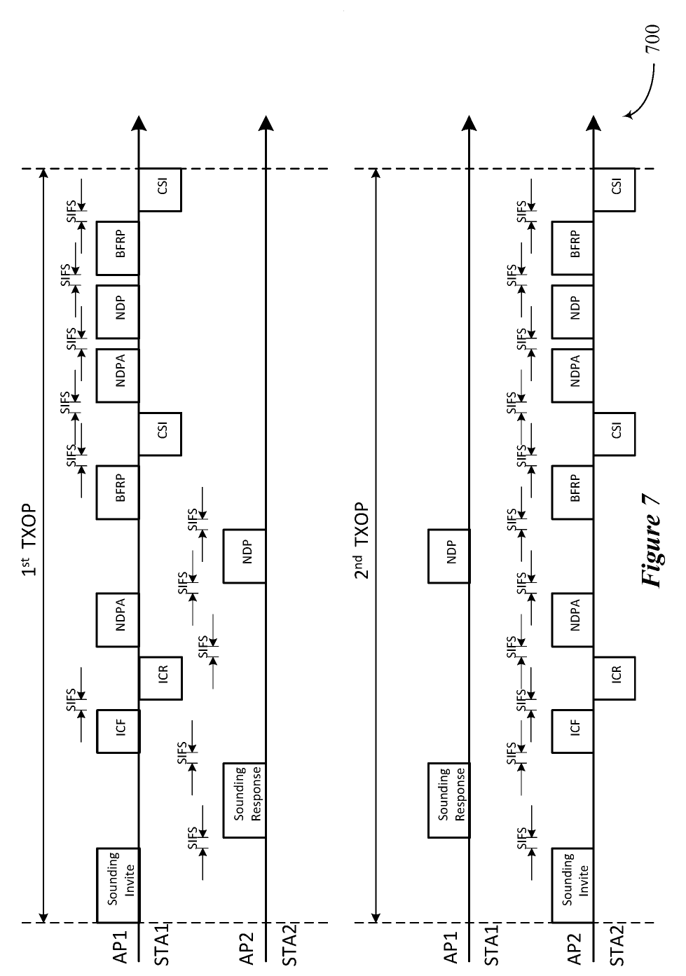

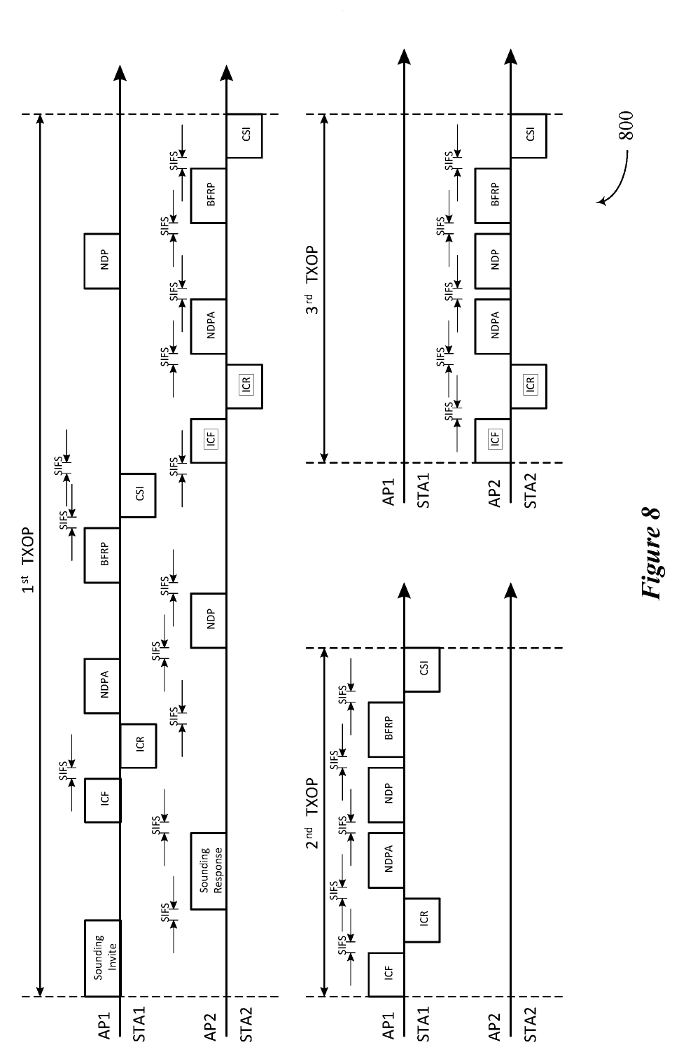

Techniques described with reference to FIGS. 7 and 8 (e.g., sounding sequences across multiple TXOPs) may implement sequential channel sounding as described with reference to FIG. 5, or may implement joint channel sounding as described with reference to FIG. 6.

FIG. 6 shows an example of a sounding sequence scheme 600 that supports transmission opportunity sounding sequences. The sounding sequence scheme 600 may implement, or be implemented by, aspects of the FIGS. 1 through 5. For example, an AP1, a STA1, an AP2, and a STA2 may be examples of corresponding devices described with reference to FIGS. 1 through 5.

In some examples, the AP1 and the AP2 may perform channel sounding (e.g., a collaborative process done by two (or more) APs to collect CSI info between each AP and the OBSS clients). CoBF channel sounding may include a sequence including a null data packet announcement (NDPA) frame, a null data packet (NDP) frame, a beamforming report poll (BFRP) frame, and a CSI report frame. An NDPA frame may announce the NDP frame, the BFRP frame may trigger the CSI report frame based on measurements taken on the NDP frame.

In some examples, the AP1 and the AP2 may perform joint sounding during a channel sounding phase of a CoBF operation. Joint sounding may support the sounding process efficiently by doing CSI estimation to the associated APs (e.g., in-BSS CSI) as well as the OBSS AP (e.g., Cross-BSS CSI) simultaneously. The sounding sequence may be similar to the sequential sounding sequence. However, the NDP frames may be sent jointly by both APs at the same time. For instance, cross-BSS and in-BSS CSI estimation for the two APs may be done using a set of separate LTFs. Joint sounding may be shorter than sequential sounding (e.g., saving up to three frame exchanges per AP), which may help to reduce signaling overhead of sounding sequences. However, joint sounding may limit a quantity of spatial streams that can be sounded on each AP and also adds additional complexity because of synchronization between NDP frames sent simultaneously.

To perform the cross-BSS CSI collection, the AP1 may perform a handshake procedure with the AP2. The handshake between APs may include a sounding invite frame and a sounding response frame exchange to ensure the availability (e.g., and willingness) of the other AP to participate in the sounding sequence. Additionally, the handshake between APs may include indications about whether each of the APs will include an ICF/ICR frame exchange with its associated STAs or not, how many associated STAs will be included in the sounding sequence, whether In-BSS sounding is needed before CoBF data transmission or not, and any other information that may be needed for successful CoBF sounding and data transmission. To perform cross-BSS sounding and in-BSS sounding, an AP may perform a handshake procedure with the STA served by the AP (e.g., an initial control frame (ICF) frame and initial control response (ICR) frame exchange) to ensure the availability of the STA to participate in the sounding sequence.

Techniques described with reference to FIGS. 7 and 8 (e.g., sounding sequences across multiple TXOPs) may implement sequential channel sounding as described with reference to FIG. 5, or may implement joint channel sounding as described with reference to FIG. 6.

FIG. 7 shows an example of a sounding sequence scheme 700 that supports multi-transmission opportunity sounding sequences. The sounding sequence scheme 700 may implement, or be implemented by, aspects of the FIGS. 1 through 6. For example, an AP1, a STA1, an AP2, and a STA2 may be examples of corresponding devices described with reference to FIGS. 1 through 6.

In some examples, the AP1 and the AP2 may perform channel sounding (e.g., a collaborative process done by two (or more) APs to collect CSI info between each AP and the OBSS clients). CoBF channel sounding may include a sequence including a null data packet announcement (NDPA) frame, a null data packet (NDP) frame, a beamforming report poll (BFRP) frame, and a CSI report frame. An NDPA frame may announce the NDP frame, the BFRP frame may trigger the CSI report frame based on measurements taken on the NDP frame.

As described herein, the length of sounding sequences in FIG. 5 and FIG. 6 (e.g., within a single TXOP) is relatively long which may make them more prone to error. Additionally, in some error scenarios, the sequence may be retransmitted from scratch, wasting time on recollecting some CSI that could have possibly been successfully collected in the first attempt. In addition to error scenarios, the STAs of one AP might not be available at the time the other AP starts the sounding sequence. This increases the probability of sounding failure.

The sounding sequence may be divided (e.g., split) into two TXOPs as shown in FIG. 7 (e.g., one for each BSS). In each TXOP, the in-BSS and cross-BSS CSI may be collected with respect to clients of a specific BSS. In such examples, for an AP to initiate a sounding sequence, the AP may only be concerned by the availability of its own clients (e.g., CSI with respect to STAs of the other AP may be collected in another TXOP owned and initiated by other APs), hence decreasing the possibility of them being unavailable. Additionally, by splitting the sequence into two TXOPs, some overhead may be saved in error cases where only the half of the sequence that failed is to be repeated.

For each BSS, the cross-BSS CSI may be collected first so that if the in-BSS CSI collection fails, only the in-BSS CSI collection is repeated using a sounding sequence that does not involve the other AP (e.g., without another handshake procedure with the other AP). The repeated in-BSS CSI collection sounding sequence may not rely on the sounding invite and sounding response frame exchange. Thus, according to techniques described herein, the in-BSS CSI collection and cross-BSS CSI collection for the first BSS (e.g., the STAs served by AP1) may be performed during a first TXOP, and the in-BSS CSI collection and the cross-BSS CSI collection for the second BSS (e.g., the STAs served by the AP2) may be performed during a second TXOP. Additional APs involved in the sounding sequence may occur in subsequent TXOPs. Such techniques may be performed in accordance with sequential sounding or joint sounding.

FIG. 8 shows an example of a sounding sequence scheme 800 that supports multi-transmission opportunity sounding sequences. The sounding sequence scheme 800 may implement, or be implemented by, aspects of the FIGS. 1 through 7. For example, an AP1, a STA1, an AP2, and a STA2 may be examples of corresponding devices described with reference to FIGS. 1 through 7.

In some examples, the AP1 and the AP2 may perform channel sounding (e.g., a collaborative process done by two (or more) APs to collect CSI info between each AP and the OBSS clients). CoBF channel sounding may include a sequence including a null data packet announcement (NDPA) frame, a null data packet (NDP) frame, a beamforming report poll (BFRP) frame, and a CSI report frame. An NDPA frame may announce the NDP frame, the BFRP frame may trigger the CSI report frame based on measurements taken on the NDP frame.

In some examples sounding sequences may be divided into multiple (e.g., three) TXOPs. During a first TXOP, the cross-BSS CSI may be collected by both APs from both BSSs. During a second and third TXOP, each respective AP may collect in-BSS CSI from each BSS (e.g., without any cross-BSS CSI collection). Alternatively, each respective AP may collect in-BSS CSI from each BSS (e.g., without any cross-BSS CSI collection) during the second TXOP. The second TXOP and/or the third TXOP may occur later than the first TXOP. Such techniques may be simple and may save power or processing resources, and may also be shorter than other sequences. For example, the two APs supporting the CoBF operation may coordinate for a single TXOP (e.g., the first TXOP), but not other TXOPs. Such a scenario exploits other sounding sequences used to collect in-BSS CSI independently from the CoBF sounding sequence, so each AP may perform in-BSS CSI on its own, without any involvement with (e.g., coordination with, handshake procedures with) other APs (e.g., legacy or default sounding sequences).

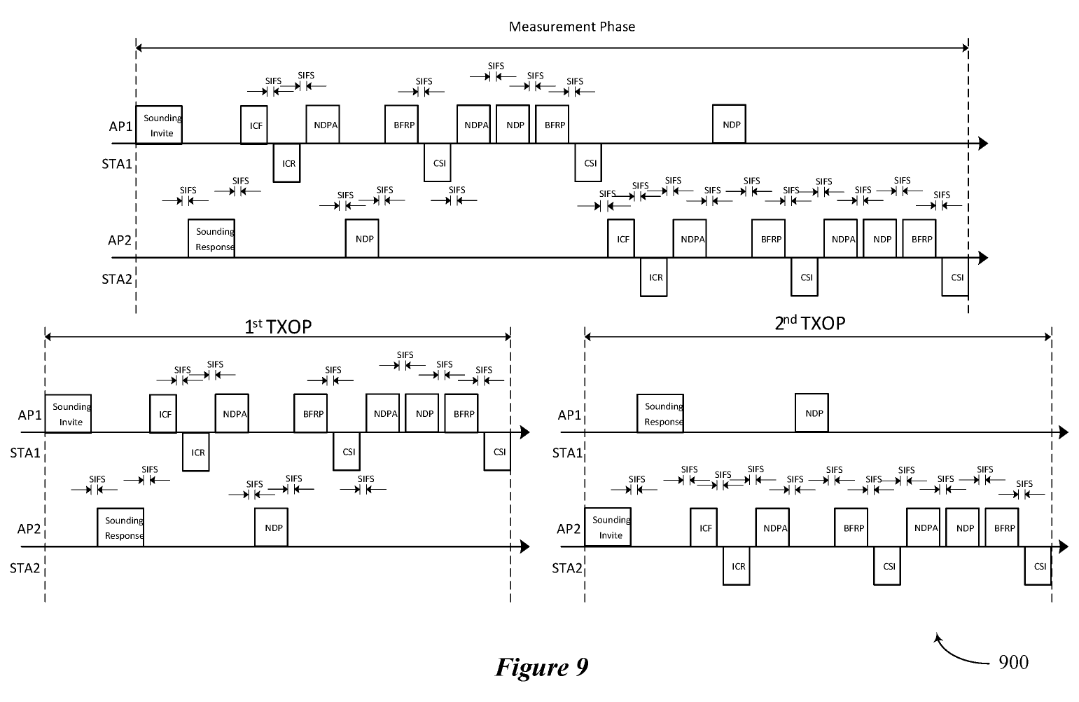

FIG. 9 shows an example of a sounding sequence scheme 900 that supports multi-transmission opportunity sounding sequences. The sounding sequence scheme 900 may implement, or be implemented by, aspects of the FIGS. 1 through 8. For example, an AP1, a STA1, an AP2, and a STA2 may be examples of corresponding devices described with reference to FIGS. 1 through 8.

In some examples, the AP1 and the AP2 may perform channel sounding (e.g., a collaborative process done by two (or more) APs to collect CSI info between each AP and the OBSS clients). CoBF channel sounding may include a sequence including a null data packet announcement (NDPA) frame, a null data packet (NDP) frame, a beamforming report poll (BFRP) frame, and a CSI report frame. An NDPA frame may announce the NDP frame, the BFRP frame may trigger the CSI report frame based on measurements taken on the NDP frame.

In some examples, the AP1 and the AP2 may perform channel sounding via a single sounding sequence in a single TXOP. In the single TXOP, the in-BSS and cross-BSS CSI may be collected with respect to clients of multiple BSSs. Additionally, for each BSS, the cross-BSS CSI may be collected first before the in-BSS CSI collection.

When performing channel sounding, the AP1 and the AP2 may first attempt to perform the channel sounding via the single sounding sequence in the single TXOP, where the cross-BSS CSI collection occurs before the in-BSS CSI collection for each BSS. In some cases, when an error occurs, a second attempt to perform the channel sounding may be via a retransmission of the single sounding sequence in an additional single TXOP (e.g., retrying the entire sounding sequence in another single TXOP). The second attempt to perform the channel sounding may be via the retransmission of the single sounding sequence (e.g., including CSI collection for both BSSs) when failure (e.g., the error) happens in the first cross-BSS CSI (e.g., by AP1) collection causing the sounding sequence to break and terminate.

Alternatively, when an error occurs, the second attempt to perform the channel sounding may be via a retransmission of part of (e.g., half) the sounding sequence if only one part failed. For example, the sounding sequence may include CSI collection by the first AP in a first part of the sequence and CSI collection by the second AP in a second part of the sequence. Thus, when the error occurs in the first part of the sequence (e.g., the first part is the part that failed), the second attempt may include a retransmission of the first part of the sequence. Conversely, when the error occurs in the second part of the sequence (e.g., the second part is the part that failed), the second attempt may include a retransmission of the second part of the sequence.

In some cases, a sounding session (e.g., including one or more sounding sequences, one or more TXOPs, or both) may be identified by a unique ID, which may be referred to as a sounding session ID (e.g., session ID). In such cases, the AP1 may generate the sounding session ID in a first TXOP belonging to a corresponding sounding session (e.g., indicating the creation of a new sounding session) and may use the sounding session ID in each additional TXOP that includes at least one sounding frame exchange related to the same sounding session. In some examples, the sounding session ID may be included in a respective sounding invite frame of each TXOP that includes at least one sounding frame exchange related to the corresponding sounding session.

A sounding session ID may be used for multi-TXOP sounding sequences. For example, when splitting a sounding sequence over multiple TXOPs, a first TXOP of the multiple TXOPs may include (e.g., create) a corresponding sounding session ID and additional TXOPs of the multiple TXOPs may reuse the same sounding session ID to indicate to another AP (e.g., AP2) which sounding session is being resumed in a current TXOP.

Additionally, or alternatively, a sounding session ID may be used for error handling. For example, in cases of an error where retransmission of a sounding sequence or parts of the sounding sequence occurs, the retransmission may indicate a sounding session ID to indicate which sounding session the retransmission is associated with.

Additionally, or alternatively, a sounding session ID may be used for coherence time handling. For example, due to mobility occurring in each BSS, collected CSI may become outdated (e.g., inapplicable) after a threshold duration. Thus, a sounding session and a corresponding sounding session ID may be used by an AP (e.g., by AP1) to track coherence time of the CSI to enable the AP to know when to initiate a new sounding sequence and create a new sounding session for the sounding sequence to collect new (e.g., fresh) CSI.

Additionally, or alternatively, a sounding session ID may be used for multi-AP CoBF engagement. That is, a sounding session ID may enable more robustness and easier tracking (e.g., as compared to when a sounding session ID is not used) when an AP is engaged in CoBF agreements with multiple APs at a same time.

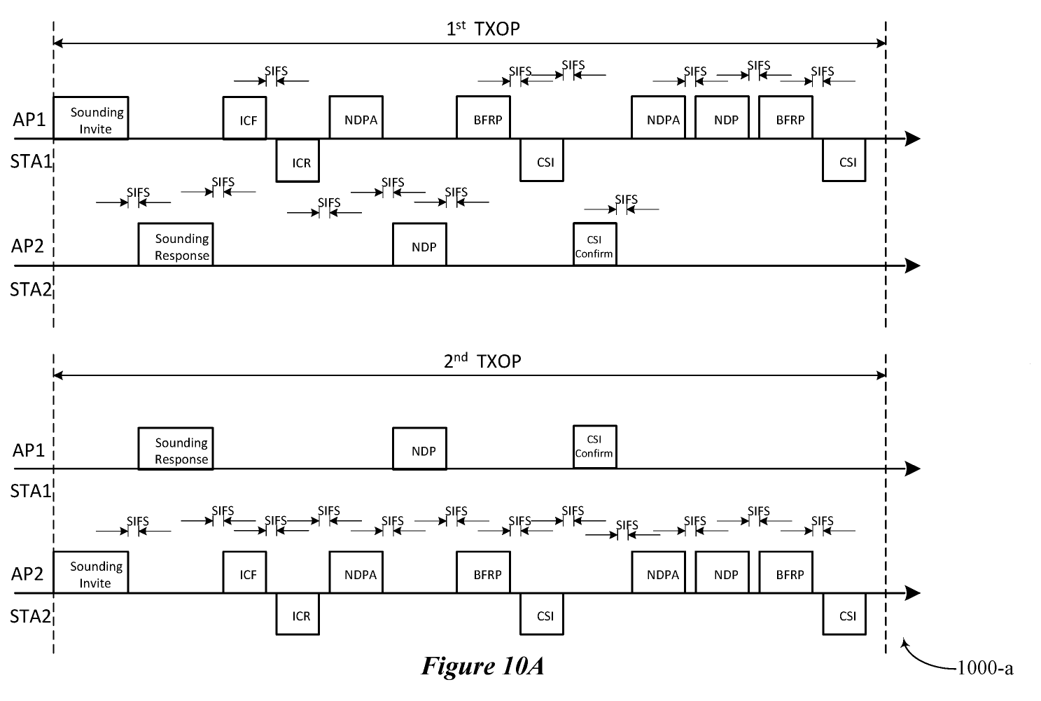

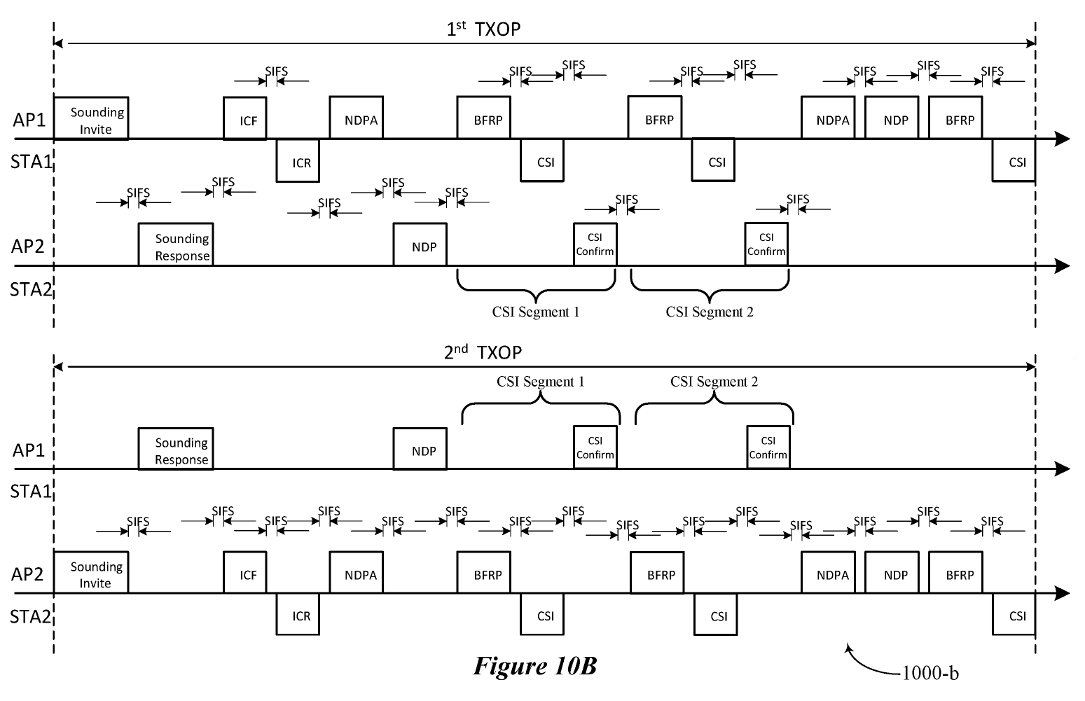

FIGS. 10A and 10B show examples of sounding sequence schemes 1000 that support multi-transmission opportunity sounding sequences. The sounding sequence schemes 1000 (e.g., a sounding reference scheme 1000-a and a sounding reference scheme 1000-b) may implement, or be implemented by, aspects of the FIGS. 1 through 9. For example, an AP1, a STA1, an AP2, and a STA2 may be examples of corresponding devices described with reference to FIGS. 1 through 9.

As discussed herein, cross-BSS CSI collection (e.g., a cross-BSS CSI collection phase) may be collaborative between a first AP with which an intended STA for CSI collection is associated and a second AP collecting the CSI. In some cases, the second AP may confirm successful reception of the CSI with the first AP (e.g., associated with the STA) so that if the reception CSI is not successful, the first AP can reinitiate a cross-BSS CSI collection portion of a sounding sequence.

In some examples, each sounding sequence may include one or more CSI feedback frames, one or more CSI confirm frames, or both. In some cases, CSI information communicated between APs in a CSI frame may be segmented into a quantity of segments, which may be referred to as CSI segments or CSI portions, such that the second AP collecting cross-BSS CSI may confirm each CSI segment or portion separately.

In some cases, as depicted in FIG. 10A with reference to a two TXOP sounding sequence (e.g., as described with reference to FIG. 7), the first AP may transmit a single CSI feedback message (e.g., single CSI feedback frame) for multiple CSI segments (e.g., portions). For example, the first AP may transmit a CSI confirm frame indicative of successful reception (e.g., positive acknowledgment (ACK), CSI confirm) when all of the multiple CSI segments (e.g., portions) are successfully received, and may transmit a CSI confirm frame indicating unsuccessful reception (e.g., negative acknowledgment (NACK), CSI fail) when at least one CSI segment (e.g., portion) of the multiple CSI segments is received unsuccessfully to request retransmission of all of the multiple CSI segments. In some other cases, the single CSI feedback message (e.g., CSI confirm frame) may include a bitmap to indicate successful or unsuccessful reception for each CSI segment separately (e.g., each bit of the bitmap corresponds to a CSI segment or a CSI portion). In such cases, the second AP may retransmit the unsuccessful CSI segments (e.g., only the failed CSI segments or the failed CSI portions).

In some other cases, as depicted in FIG. 10B with reference to a two TXOP sounding sequence (e.g., as described with reference to FIG. 7), the first AP may transmit a CSI feedback message (e.g., CSI confirm frame, CSI feedback frame) for each CSI segment (e.g., portion) of the multiple CSI segments. That is, the sounding sequence may be broken down (e.g., grouped) into the multiple CSI segments (e.g., BFRP-CSI) and each CSI segment (e.g., portion) may be confirmed separately. Though described in the context of a two TXOP sounding sequence, this is not to be regarded as a limitation of the present disclosure, such that the techniques described herein may be applicable to any quantity of TXOPs, including, but not limited to, a single TXOP sounding sequence and a three TXOP sounding sequence.

Additionally, or alternatively, the first AP (e.g., receiving the CSI) may transmit an indication of feedback associated with cross-BSS CSI collection in a second TXOP that occurs after a first TXOP in which the cross-BSS CSI was collected. That is, the first AP may receive an indication of the cross-BSS CSI in the first TXOP and may transmit feedback associated with reception of the cross-BSS CSI during a second TXOP, where the second TXOP is subsequent to the first TXOP (e.g., is a next TXOP).

As described herein, in some cases, a sounding sequence may be associated with a single TXOP (e.g., single TXOP sounding sequence). In such cases, both cross-BSS CSIs collected during a first TXOP may be confirmed (e.g., by the first AP and by the second AP) at a beginning of a next transmission sequence using a CoBF invite frame (e.g., a first message of an initial AP-to-AP handshake at the beginning of a CoBF data transmission sequence), or a CoBF response frame (e.g., a second message of the initial AP-to-AP handshake at the beginning of the CoBF data transmission sequence). In such cases, if either of the two cross-BSS CSIs were not successfully received, then the next transmission sequence may be terminated and the first AP and the second AP may repeat (e.g., redo) the sounding sequence or at least one or more parts of the sounding sequence that failed.

In some other cases, as described herein, a sounding sequence may be associated with three TXOPs (e.g., three TXOP sounding sequence). In such cases, both cross-BSS CSIs collected during a first TXOP (e.g., of the three TXOPs) may be confirmed (e.g., by the first AP and by the second AP) at a beginning of a next transmission sequence using a CoBF invite frame (e.g., a first message of an initial AP-to-AP handshake at the beginning of a CoBF data transmission sequence), or a CoBF response frame (e.g., a second message of the initial AP-to-AP handshake at the beginning of the CoBF data transmission sequence). In such cases, if either of the two cross-BSS CSIs were not successfully received, then the transmission sequence may be terminated and the first AP and the second AP may repeat (e.g., redo) the sounding sequence. In some cases, if one AP of the first AP and the second AP fails to collect corresponding in-BSS CSI, was unable to recollect the corresponding in-BSS CSI (e.g., in another separate TXOP), and is unable to start a next CoBF data transmission sequence (e.g., TXOP) without the corresponding in-BSS, the AP may indicate the corresponding in-BSS CSI was not collected in a CoBF response frame at a beginning of a next transmission sequence. In such cases, the next transmission sequence may be terminated, and the AP may retry the in-BSS CSI collection procedure.

In some other cases, as described herein, a sounding sequence may be associated with two TXOPs (e.g., two TXOP sounding sequence). In the following discussion, first cross-BSS CSI may refer to cross-BSS CSI initiated by the AP1 and collected by the AP2 (e.g., is confirmed by the AP2), and a second cross-BSS CSI may refer to cross-BSS CSI initiated by the AP2 and collected by the AP1 (e.g., is confirmed by the AP1). In some cases, both the first cross-BSS CSI and the second cross-BSS CSI may be successful. In such cases, the first cross-BSS CSI may be confirmed by the AP2 in a second TXOP (e.g., of the two TXOPs) and the second cross-BSS CSI may be confirmed by the AP1 at a beginning of a next CoBF data transmission sequence (e.g., via an implicit or explicit CSI confirm).

In some other cases, the AP1 may initiate the first cross-BSS CSI collection sequence and the AP2 may transmit feedback (e.g., a NACK) at a beginning of a second TXOP (e.g., of the two TXOPs) indicating unsuccessful reception of the first cross-BSS CSI (e.g., in a sounding invite frame). In such cases, the second cross-BSS CSI may be collected during the second TXOP. Additionally, the AP1 may attempt to retry a sequence for the first cross-BSS CSI and confirm successful reception of the second cross-BSS CSI. Thus, the AP2 may confirm successful collection of the first cross-BSS CSI at a beginning of a next CoBF data transmission sequence. In some cases, CSI failure may be indicated by either of the AP1 or the AP2 at a beginning of a CoBF data transmission sequence and, in such cases, the CoBF data transmission sequence may be terminated.

In some other cases, the AP1 may initiate the first cross-BSS CSI collection sequence and the AP2 may confirm successful collection of the first cross-BSS CSI at the beginning of the second TXOP (e.g., of the two TXOPs) and may initiate a sequence for the second cross-BSS CSI collection. Additionally, the AP1 may transmit (e.g., a NACK) at a beginning of a next CoBF data transmission sequence indicating unsuccessful reception of the second cross-BSS CSI. In such cases, the AP2 may retry the sequence for the second cross-BSS CSI and the AP1 may confirm successful collection of the second cross-BSS CSI at a beginning of a subsequent CoBF data transmission sequence. In some cases, CSI failure may be indicated by either of the AP1 or the AP2 at a beginning of a CoBF data transmission sequence and, in such cases, the CoBF data transmission sequence may be terminated.

In some embodiments, the term CSI feedback can be referred to as Compressed Beamforming (CBF) feedback (e.g., report), Channel Quality Information/Indication (CQI), or both.

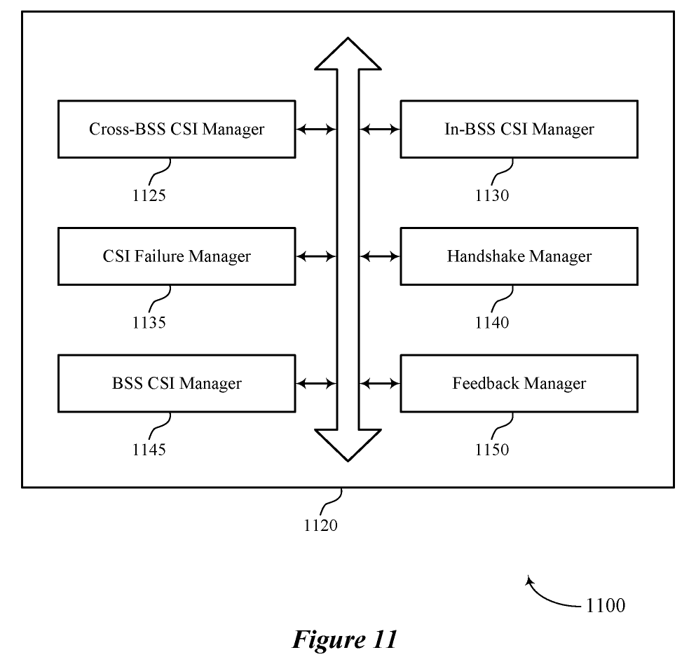

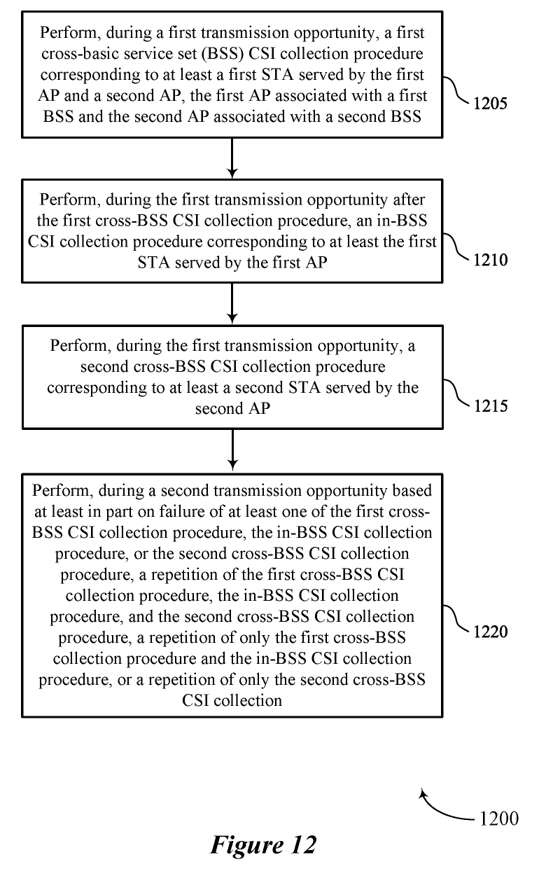

FIG. 11 shows a block diagram of an example wireless communication device 1100 that supports multi-transmission opportunity sounding sequences. In some examples, the wireless communication device 1100 is configured to perform the processes 1200, 1300, and 1400 described with reference to FIGS. 12, 13, and 14, respectively. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP, such as the AP 102 described with reference to FIG. 1. In some other examples, the wireless communication device 1100 can be an AP that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes a cross-BSS CSI manager 1125, an in-BSS CSI manager 1130, a CSI failure manager 1135, a handshake manager 1140, a BSS CSI manager 1145, and a feedback manager 1150. Portions of one or more of the cross-BSS CSI manager 1125, the in-BSS CSI manager 1130, the CSI failure manager 1135, the handshake manager 1140, the BSS CSI manager 1145, and the feedback manager 1150 may be implemented at least in part in hardware or firmware. For example, one or more of the cross-BSS CSI manager 1125, the in-BSS CSI manager 1130, the CSI failure manager 1135, the handshake manager 1140, the BSS CSI manager 1145, and the feedback manager 1150 may be implemented at least in part by at least a processor or a modem. In some examples, portions of one or more of the cross-BSS CSI manager 1125, the in-BSS CSI manager 1130, the CSI failure manager 1135, the handshake manager 1140, the BSS CSI manager 1145, and the feedback manager 1150 may be implemented at least in part by a processor and software in the form of processor-executable code stored in memory.

The wireless communication device 1100 may support wireless communications in accordance with examples as disclosed herein. The cross-BSS CSI manager 1125 is configurable or configured to perform, during a first transmission opportunity, a first cross-basic service set (BSS) channel state information (CSI) collection procedure corresponding to at least a first station (STA) served by the first AP and a second AP, the first AP associated with a first BSS and the second AP associated with a second BSS. The in-BSS CSI manager 1130 is configurable or configured to perform, during the first transmission opportunity after the first cross-BSS CSI collection procedure, an in-BSS CSI collection procedure corresponding to at least the first STA served by the first AP. The cross-BSS CSI manager 1125 is configurable or configured to perform, during the first transmission opportunity, a second cross-BSS CSI collection procedure corresponding to at least a second STA served by the second AP. The CSI failure manager 1135 is configurable or configured to perform, during a second transmission opportunity based at least in part on failure of at least one of the first cross-BSS CSI collection procedure, the in-BSS CSI collection procedure, or the second cross-BSS CSI collection procedure, a repetition of the first cross-BSS CSI collection procedure, the in-BSS CSI collection procedure, and the second cross-BSS CSI collection procedure, a repetition of only the first cross-BSS CSI collection procedure and the in-BSS CSI collection procedure, or a repetition of only the second cross-BSS CSI collection procedure.

In some examples, the repetition of only the first cross-BSS CSI collection procedure and the in-BSS CSI collection procedure is performed during the second transmission opportunity based at least in part on failure of at least one of the first cross-BSS CSI collection procedure or the in-BSS CSI collection procedure during the first transmission opportunity.

In some examples, the repetition of only the second cross-BSS CSI collection procedure is performed during the second transmission opportunity based at least in part on the failure of the second cross-BSS CSI collection procedure during the first transmission opportunity.

Additionally, or alternatively, the wireless communication device 1100 may support wireless communications in accordance with examples as disclosed herein. The handshake manager 1140 is configurable or configured to transmit, during a first transmission opportunity, a first sounding invite frame indicative of a first sounding session identifier associated with a first sounding session executed over one or more transmission opportunities, the one or more transmission opportunities including at least the first transmission opportunity. The BSS CSI manager 1145 is configurable or configured to perform, during the first transmission opportunity, one or more first basic service set (BSS) channel state information (CSI) collection procedures based on reception of the first sounding invite frame. In some examples, the handshake manager 1140 is configurable or configured to communicate, during a second transmission opportunity, a second sounding invite frame indicative of a second sounding session identifier, where the second sounding session identifier is the same as the first sounding session identifier based on the first transmission opportunity and the second transmission opportunity being associated with the first sounding session corresponding to the first sounding session identifier or the second sounding session identifier is different than the first sounding session identifier based on the second transmission opportunity being associated with a second sounding session corresponding to the second sounding session identifier, the second sounding session different than the first sounding session. In some examples, the BSS CSI manager 1145 is configurable or configured to perform, during the second transmission opportunity, one or more second BSS CSI collection procedures based on communication of the second sounding invite frame.

Additionally, or alternatively, the wireless communication device 1100 may support wireless communications in accordance with examples as disclosed herein. In some examples, the cross-BSS CSI manager 1125 is configurable or configured to perform, during a first transmission opportunity, a first cross-basic service set (BSS) channel state information (CSI) collection procedure corresponding to at least a first station (STA) served by the first AP and a second AP, the first AP associated with a first BSS and the second AP associated with a second BSS, where the first cross-BSS CSI collection procedure includes a set of multiple CSI segments (e.g., portions). The feedback manager 1150 is configurable or configured to receive, from the second AP, at least one feedback message based on the first cross-BSS CSI collection procedure.

In some examples, the at least one feedback message includes a single feedback message associated with the set of multiple CSI segments (e.g., portions), the single feedback message received after completion of the set of multiple CSI segments.

In some examples, the at least one feedback message includes a respective feedback message associated with each CSI segment (e.g., portion) of the set of multiple CSI segments, each feedback message received after a corresponding CSI segment.

In some examples, the at least one feedback message (e.g., at least one CSI confirm frame) is received during the first transmission opportunity.

In some examples, the at least one feedback message (e.g., at least one CSI confirm frame) includes a single feedback message received during a second transmission opportunity subsequent to the first transmission opportunity.

FIG. 12 shows a flowchart illustrating an example process 1200 performable by or at a first AP that supports multi-transmission opportunity sounding sequences. The operations of the process 1200 may be implemented by a first AP or its components as described herein. For example, the process 1200 may be performed by a wireless communication device, such as the wireless communication device 1100 described with reference to FIG. 11, operating as or within a wireless AP. In some examples, the process 1200 may be performed by a wireless AP, such as one of the APs102 described with reference to FIG. 1.

In some examples, in 1205, the first AP may perform, during a first transmission opportunity, a first cross-basic service set (BSS) CSI collection procedure corresponding to at least a first STA served by the first AP and a second AP, the first AP associated with a first BSS and the second AP associated with a second BSS. The operations of 1205 may be performed in accordance with examples as disclosed herein. In some implementations, aspects of the operations of 1205 may be performed by a cross-BSS CSI manager 1125 as described with reference to FIG. 11.

In some examples, in 1210, the first AP may perform, during the first transmission opportunity after the first cross-BSS CSI collection procedure, an in-BSS CSI collection procedure corresponding to at least the first STA served by the first AP. The operations of 1210 may be performed in accordance with examples as disclosed herein. In some implementations, aspects of the operations of 1210 may be performed by an in-BSS CSI manager 1130 as described with reference to FIG. 11.

In some examples, in 1215, the first AP may perform, during the first transmission opportunity, a second cross-BSS CSI collection procedure corresponding to at least a second STA served by the second AP. The operations of 1215 may be performed in accordance with examples as disclosed herein. In some implementations, aspects of the operations of 1215 may be performed by a cross-BSS CSI manager 1125 as described with reference to FIG. 11.

In some examples, in 1220, the first AP may perform, during a second transmission opportunity based at least in part on failure of at least one of the first cross-BSS CSI collection procedure, the in-BSS CSI collection procedure, or the second cross-BSS CSI collection procedure, a repetition of the first cross-BSS CSI collection procedure, the in-BSS CSI collection procedure, and the second cross-BSS CSI collection procedure, a repetition of only the first cross-BSS CSI collection procedure and the in-BSS CSI collection procedure, or a repetition of only the second cross-BSS CSI collection procedure. The operations of 1220 may be performed in accordance with examples as disclosed herein. In some implementations, aspects of the operations of 1220 may be performed by a CSI failure manager 1135 as described with reference to FIG. 11.

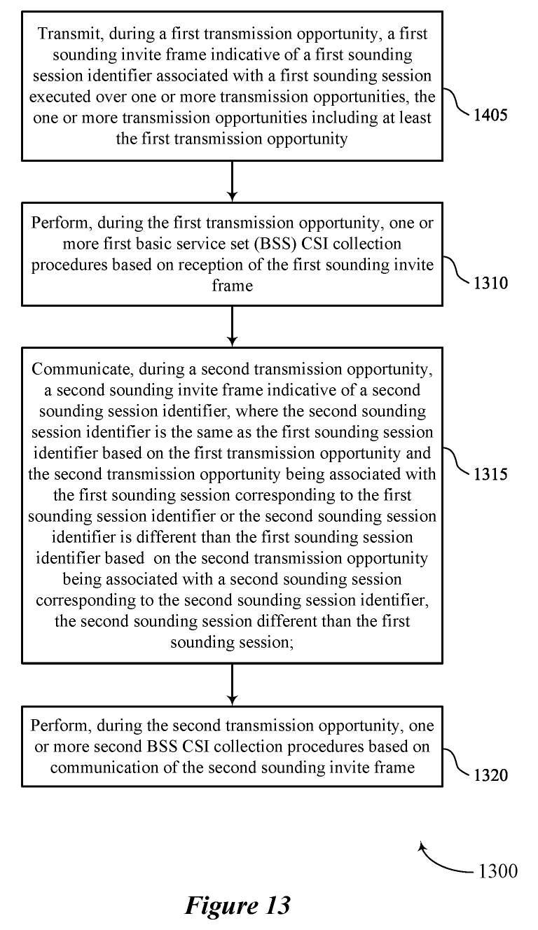

FIG. 13 shows a flowchart illustrating an example process 1300 performable by or at a first AP that supports multi-transmission opportunity sounding sequences. The operations of the process 1300 may be implemented by a first AP or its components as described herein. For example, the process 1300 may be performed by a wireless communication device, such as the wireless communication device 1100 described with reference to FIG. 11, operating as or within a wireless AP. In some examples, the process 1300 may be performed by a wireless AP, such as one of the APs 102 described with reference to FIG. 1.

In some examples, in 1305, the first AP may transmit, during a first transmission opportunity, a first sounding invite frame indicative of a first sounding session identifier associated with a first sounding session executed over one or more transmission opportunities, the one or more transmission opportunities including at least the first transmission opportunity. The operations of 1305 may be performed in accordance with examples as disclosed herein. In some implementations, aspects of the operations of 1305 may be performed by a handshake manager 1140 as described with reference to FIG. 11.

In some examples, in 1310, the first AP may perform, during the first transmission opportunity, one or more first basic service set (BSS) CSI collection procedures based on reception of the first sounding invite frame. The operations of 1310 may be performed in accordance with examples as disclosed herein. In some implementations, aspects of the operations of 1310 may be performed by a BSS CSI manager 1145 as described with reference to FIG. 11.

In some examples, in 1315, the first AP may communicate, during a second transmission opportunity, a second sounding invite frame indicative of a second sounding session identifier, wherein the second sounding session identifier is the same as the first sounding session identifier based at least in part on the first transmission opportunity and the second transmission opportunity being associated with the first sounding session corresponding to the first sounding session identifier or the second sounding session identifier is different than the first sounding session identifier based at least in part on the second transmission opportunity being associated with a second sounding session corresponding to the second sounding session identifier, the second sounding session different than the first sounding session. The operations of 1315 may be performed in accordance with examples as disclosed herein. In some implementations, aspects of the operations of 1315 may be performed by a handshake manager 1140 as described with reference to FIG. 11.

In some examples, in 1320, the first AP may perform, during the second transmission opportunity, one or more second BSS CSI collection procedures based on communication of the second sounding invite frame. The operations of 1320 may be performed in accordance with examples as disclosed herein. In some implementations, aspects of the operations of 1320 may be performed by a BSS CSI manager 1145 as described with reference to FIG. 11.

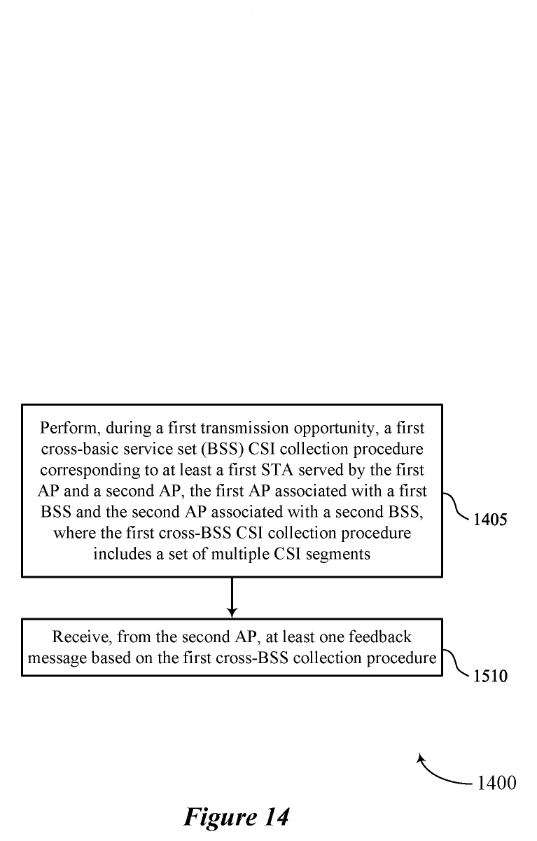

FIG. 14 shows a flowchart illustrating an example process 1400 performable by or at a first AP that supports multi-transmission opportunity sounding sequences. The operations of the process 1400 may be implemented by a first AP or its components as described herein. For example, the process 1400 may be performed by a wireless communication device, such as the wireless communication device 1100 described with reference to FIG. 11, operating as or within a wireless AP. In some examples, the process 1400 may be performed by a wireless AP, such as one of the APs 102 described with reference to FIG. 1.

In some examples, in 1405, the first AP may perform, during a first transmission opportunity, a first cross-basic service set (BSS) CSI collection procedure corresponding to at least a first STA served by the first AP and a second AP, the first AP associated with a first BSS and the second AP associated with a second BSS, where the first cross-BSS CSI collection procedure includes a set of multiple CSI segments. The operations of 1405 may be performed in accordance with examples as disclosed herein. In some implementations, aspects of the operations of 1405 may be performed by a cross-BSS CSI manager 1125 as described with reference to FIG. 11.

In some examples, in 1410, the first AP may receive, from the second AP, at least one feedback message based on the first cross-BSS CSI collection procedure. The operations of 1410 may be performed in accordance with examples as disclosed herein. In some implementations, aspects of the operations of 1410 may be performed by a feedback manager 1150 as described with reference to FIG. 11.

Implementation examples are described in the following numbered clauses:

Aspect 1: A method for wireless communications at a first AP, comprising: performing, during a first transmission opportunity, a first cross-basic service set (BSS) CSI collection procedure corresponding to at least a first STA served by the first AP and a second AP, the first AP associated with a first BSS and the second AP associated with a second BSS; performing, during the first transmission opportunity after the first cross-BSS CSI collection procedure, an in-BSS CSI collection procedure corresponding to at least the first STA served by the first AP; performing, during the first transmission opportunity, a second cross-BSS CSI collection procedure corresponding to at least a second STA served by the second AP; and performing, during a second transmission opportunity based at least in part on failure of at least one of the first cross-BSS CSI collection procedure, the in-BSS CSI collection procedure, or the second cross-BSS CSI collection procedure, a repetition of the first cross-BSS CSI collection procedure, the in-BSS CSI collection procedure, and the second cross-BSS CSI collection procedure, a repetition of only the first cross-BSS CSI collection procedure and the in-BSS CSI collection procedure, or a repetition of only the second cross-BSS CSI collection procedure.

Aspect 2: The method of aspect 1, wherein the repetition of only the first cross-BSS CSI collection procedure and the in-BSS CSI collection procedure is performed during the second transmission opportunity based at least in part on failure of at least one of the first cross-BSS CSI collection procedure or the in-BSS CSI collection procedure during the first transmission opportunity.

Aspect 3: The method of any of aspects 1 through 2, wherein the repetition of only the second cross-BSS CSI collection procedure is performed during the second transmission opportunity based at least in part on the failure of the second cross-BSS CSI collection procedure during the first transmission opportunity.

Aspect 4: A method for wireless communications at a first AP, comprising: transmitting, during a first transmission opportunity, a first sounding invite frame indicative of a first sounding session identifier associated with a first sounding session executed over one or more transmission opportunities, the one or more transmission opportunities comprising at least the first transmission opportunity; performing, during the first transmission opportunity, one or more first basic service set (BSS) CSI collection procedures based at least in part on reception of the first sounding invite frame; communicating, during a second transmission opportunity, a second sounding invite frame indicative of a second sounding session identifier, wherein the second sounding session identifier is the same as the first sounding session identifier based at least in part on the first transmission opportunity and the second transmission opportunity being associated with the first sounding session corresponding to the first sounding session identifier or the second sounding session identifier is different than the first sounding session identifier based at least in part on the second transmission opportunity being associated with a second sounding session corresponding to the second sounding session identifier, the second sounding session different than the first sounding session; and performing, during the second transmission opportunity, one or more second BSS CSI collection procedures based at least in part on communication of the second sounding invite frame.

Aspect 5: A method for wireless communications at a first AP, comprising: performing, during a first transmission opportunity, a first cross-basic service set (BSS) CSI collection procedure corresponding to at least a first STA served by the first AP and a second AP, the first AP associated with a first BSS and the second AP associated with a second BSS, wherein the first cross-BSS CSI collection procedure comprises a plurality of CSI segments (e.g., portions); and receiving, from the second AP, at least one feedback message based at least in part on the first cross-BSS CSI collection procedure.

Aspect 6: The method of aspect 5, wherein the at least one feedback message comprises a single feedback message associated with the plurality of CSI segments (e.g., portions), the single feedback message received after completion of the plurality of CSI segments.

Aspect 7: The method of any of aspects 5 through 6, wherein the at least one feedback message comprises a respective feedback message associated with each CSI segment (e.g., portion) of the plurality of CSI segments, each feedback message received after a corresponding CSI segment.

Aspect 8: The method of any of aspects 5 through 7, wherein the at least one feedback message is received during the first transmission opportunity.

Aspect 9: The method of any of aspects 5 through 8, wherein the at least one feedback message comprises a single feedback message received during a second transmission opportunity subsequent to the first transmission opportunity.

Aspect 10: A first AP for wireless communications, comprising one or more memories storing processor-executable code, and one or more processors coupled with the one or more memories and individually or collectively operable to execute the code to cause the first AP to perform a method of any of aspects 1 through 3.

Aspect 11: A first AP for wireless communications, comprising at least one means for performing a method of any of aspects 1 through 3.

Aspect 12: A non-transitory computer-readable medium storing code for wireless communications, the code comprising instructions executable by one or more processors to perform a method of any of aspects 1 through 3.

Aspect 13: A first AP for wireless communications, comprising one or more memories storing processor-executable code, and one or more processors coupled with the one or more memories and individually or collectively operable to execute the code to cause the first AP to perform a method of any of aspects 4 through 9.

Aspect 14: A first AP for wireless communications, comprising at least one means for performing a method of any of aspects 4 through 9.

Aspect 15: A non-transitory computer-readable medium storing code for wireless communications, the code comprising instructions executable by one or more processors to perform a method of any of aspects 4 through 9.

Aspect 16: A first AP for wireless communications, comprising one or more memories storing processor-executable code, and one or more processors coupled with the one or more memories and individually or collectively operable to execute the code to cause the first AP to perform a method of any of aspects 5 through 9.

Aspect 17: A first AP for wireless communications, comprising at least one means for performing a method of any of aspects 5 through 9.

Aspect 18: A non-transitory computer-readable medium storing code for wireless communications, the code comprising instructions executable by one or more processors to perform a method of any of aspects 5 through 9.

Aspect 19: A method by a first AP, comprising: performing, during a first transmission opportunity, a first cross-basic service set (BSS) CSI collection procedure corresponding to at least a first STA served by the first AP and a second AP, the first AP associated with a first BSS and the second AP associated with a second BSS; performing, during the first transmission opportunity and after the first cross-BSS CSI collection procedure, an in-BSS CSI collection procedure corresponding to at least the first STA served by the first AP; and performing, during the first transmission opportunity or during a second transmission opportunity in accordance with information exchanged via a first initial handshake procedure between the first AP and the second AP, a second cross-BSS CSI collection procedure corresponding to at least a second STA served by the second AP.

Aspect 20: The method of aspect 19, further comprising: detecting a failure of the in-BSS CSI collection procedure; and reinitiating the in-BSS CSI collection procedure based at least in part on the detecting.

Aspect 21: The method of any of aspects 19 through 20, further comprising: refraining from performing a second initial handshake procedure with the second AP after detecting a failure of the in-BSS CSI collection procedure and prior to reinitiating the in-BSS CSI collection procedure.

Aspect 22: The method of any of aspects 19 through 21, wherein performing the first cross-BSS CSI collection procedure comprises: performing the first initial handshake procedure with the second AP and a second handshake procedure with the first STA; transmitting a null data packet announcement (NDPA) frame that triggers a null data packet (NDP) frame by the second AP; transmitting, after the NDP frame is transmitted by the second AP, a beamforming report poll (BFRP) frame; and receiving a CSI report message from the first STA in accordance with the BFRP frame.

Aspect 23: The method of any of aspects 19 through 22, wherein performing the in-BSS CSI collection procedure comprises: transmitting, in accordance with a previous handshake procedure with the first STA before the first cross-BSS CSI collection procedure, a null data packet announcement (NDPA) frame that indicates a null data packet (NDP) frame; transmitting the NDP frame; transmitting a beamforming report poll (BFRP) frame; and receiving a CSI report message from the first STA in accordance with the BFRP frame.

Aspect 24: The method of any of aspects 19 through 23, wherein performing the second cross-BSS CSI collection procedure comprises: performing the first initial handshake procedure with the second AP; detecting a null data packet announcement (NDPA) frame from the second AP that triggers a null data packet (NDP) frame by the first AP; transmitting the NDP frame in accordance with the NDPA frame; and receiving a CSI report message from the second STA in accordance with the NDP frame.

Aspect 25: The method of any of aspects 19 through 24, further comprising: performing, during the second transmission opportunity based at least in part on failure of at least one of the first cross-BSS CSI collection procedure, the in-BSS CSI collection procedure, and the second cross-BSS CSI collection procedure, a repetition of the first cross-BSS CSI collection procedure, the in-BSS CSI collection procedure, and the second cross-BSS CSI collection procedure, a repetition of only the first cross-BSS CSI collection procedure and the in-BSS CSI collection procedure, or a repetition of only the second cross-BSS CSI collection procedure.

Aspect 26: The method of aspect 25, wherein the repetition of only the first cross-BSS CSI collection procedure and the in-BSS CSI collection procedure is performed during the second transmission opportunity based at least in part on failure of at least one of the first cross-BSS CSI collection procedure and the in-BSS CSI collection procedure during the first transmission opportunity.

Aspect 27: The method of any of aspects 25 through 26, wherein the repetition of only the second cross-BSS CSI collection procedure is performed during the second transmission opportunity based at least in part on the failure of the second cross-BSS CSI collection procedure during the first transmission opportunity.

Aspect 28: The method of any of aspects 19 through 27, further comprising: performing, after the second cross-BSS CSI collection procedure, a second in-BSS CSI collection procedure corresponding to at least the second STA served by the second AP.

Aspect 29: A method by a first AP, comprising: performing, during a first transmission opportunity, a first cross-basic service set (BSS) CSI collection procedure corresponding to at least a first STA served by the first AP and a second AP, the first AP associated with a first BSS and the second AP associated with a second BSS; performing, during the first transmission opportunity, a second cross-BSS CSI collection procedure corresponding to at least a second STA served by the second AP; and performing, during a second transmission opportunity, an in-BSS CSI collection procedure corresponding to at least the first STA.

Aspect 30: The method of aspect 29, wherein performing the first cross-BSS CSI collection procedure comprises: performing a first handshake procedure with the second AP and a second handshake procedure with the first STA; transmitting a null data packet announcement (NDPA) frame that triggers a null data packet (NDP) frame by the second AP; transmitting, after the NDP frame is transmitted by the second AP, a beamforming report poll (BFRP) frame; and receiving a CSI report message from the first STA in accordance with the BFRP frame.

Aspect 31: The method of any of aspects 29 through 30, wherein performing the second cross-BSS CSI collection procedure comprises: detecting, in accordance with a previous handshake procedure with the second AP, a null data packet announcement (NDPA) frame from the second AP that triggers a null data packet (NDP) frame by the first AP; transmitting the NDP frame in accordance with the NDPA frame; and receiving a CSI report message from the second STA in response to a beamforming report poll (BFRP) frame from the second AP and in accordance with the NDP frame.

Aspect 32: The method of any of aspects 29 through 31, wherein performing the in-BSS CSI collection procedure comprises: performing a handshake procedure with the first STA; transmitting a null data packet announcement (NDPA) frame that indicates a null data packet (NDP) frame; transmitting the NDP frame in accordance with the NDPA frame; transmitting a beamforming report poll (BFRP) frame in accordance with the NDP frame; and receiving a CSI report message from the first STA in accordance with the BFRP frame.

Aspect 33: A method by a first AP, comprising: performing, during a first transmission opportunity, a first cross-basic service set (BSS) CSI collection procedure corresponding to at least a first STA served by the first AP and a second AP, the first AP associated with a first BSS and the second AP associated with a second BSS, wherein the first cross-BSS CSI collection procedure comprises a plurality of CSI portions; and receiving, from the second AP, at least one feedback message based at least in part on the first cross-BSS CSI collection procedure.

Aspect 34: The method of aspect 33, wherein the at least one feedback message comprises a single feedback message associated with the plurality of CSI portions, the single feedback message received after completion of the plurality of CSI portions.

Aspect 35: The method of any of aspects 33 through 34, wherein the at least one feedback message comprises a respective feedback message associated with each CSI portion of the plurality of CSI portions, each feedback message received after a corresponding CSI portion.

Aspect 36: The method of any of aspects 33 through 35, wherein the at least one feedback message is received during the first transmission opportunity.

Aspect 37: The method of any of aspects 33 through 36, wherein the at least one feedback message comprises a single feedback message received during a second transmission opportunity subsequent to the first transmission opportunity.

Aspect 38: The method of any of aspects 33 through 37, further comprising: transmitting a first CSI confirm frame indicating successful reception when each CSI portion of the plurality of CSI portions is successfully received, wherein the first CSI confirm frame is transmitted during the first transmission opportunity or during a second transmission opportunity later than the first transmission opportunity; and transmitting a second CSI confirm frame indicating unsuccessful reception when at least one CSI portion of the plurality of CSI portions is unsuccessfully received, the second CSI confirm frame requesting retransmission of at least one CSI portion of the plurality of CSI portions, wherein the second CSI confirm frame is transmitted during the first transmission opportunity or during a second transmission opportunity later than the first transmission opportunity.

Aspect 39: A method by a first AP, comprising: transmitting, during a first transmission opportunity, a first sounding invite frame associated with a first sounding session executed over one or more transmission opportunities, the one or more transmission opportunities comprising at least the first transmission opportunity; performing, during the first transmission opportunity, one or more first basic service set (BSS) CSI collection procedures based at least in part on reception of the first sounding invite frame; communicating, during a second transmission opportunity, a second sounding invite frame, wherein the second sounding invite frame is associated with the first sounding session based at least in part on the first transmission opportunity and the second transmission opportunity being associated with the first sounding session or the second sounding invite frame is associated with a second sounding session based at least in part on the second transmission opportunity being associated with the second sounding session, the second sounding session different than the first sounding session; and performing, during the second transmission opportunity, one or more second BSS CSI collection procedures based at least in part on communication of the second sounding invite frame.

Aspect 40: The method of aspect 39, wherein in an event of a retransmission of at least a portion of the first sounding session, the retransmission is associated with the first sounding session based at least in part on the first sounding invite frame.

Aspect 41: The method of any of aspects 39 through 40, further comprising: tracking a coherence time associated with the one or more first BSS CSI collection procedures based at least in part on the first sounding session; transmitting, based at least in part on determining that information collected via the one or more first BSS CSI collection procedures is outdated, a third sounding invite frame associated with a third sounding session; and performing, during the third sounding session, one or more third BSS CSI collection procedures based at least in part on transmission of the third sounding invite frame.

Aspect 42: The method of any of aspects 39 through 41, wherein each of the first sounding invite frame and the second sounding invite frame indicate a first sounding session identifier associated with the first sounding session based at least in part on the first transmission opportunity and the second transmission opportunity being associated with the first sounding session.

Aspect 43: The method of any of aspects 39 through 42, wherein the first sounding invite frame indicates a first sounding session identifier associated with the first sounding session and the second sounding invite frame indicates a second sounding session identifier associated with the second sounding session based at least in part on the second transmission opportunity being associated with the second sounding session.

Aspect 44: A first AP comprising a processing system that includes processor circuitry and memory circuitry that stores code, the processing system configured to cause the first AP to perform a method of any of aspects 19 through 28.

Aspect 45: A first AP comprising at least one means for performing a method of any of aspects 19 through 28.

Aspect 46: A non-transitory computer-readable medium storing code the code comprising instructions executable by one or more processors to perform a method of any of aspects 19 through 28.

Aspect 47: A first AP comprising a processing system that includes processor circuitry and memory circuitry that stores code, the processing system configured to cause the first AP to perform a method of any of aspects 29 through 32.

Aspect 48: A first AP comprising at least one means for performing a method of any of aspects 29 through 32.

Aspect 49: A non-transitory computer-readable medium storing code the code comprising instructions executable by one or more processors to perform a method of any of aspects 29 through 32.

Aspect 50: A first AP comprising a processing system that includes processor circuitry and memory circuitry that stores code, the processing system configured to cause the first AP to perform a method of any of aspects 33 through 38.

Aspect 51: A first AP comprising at least one means for performing a method of any of aspects 33 through 38.

Aspect 52: A non-transitory computer-readable medium storing code the code comprising instructions executable by one or more processors to perform a method of any of aspects 33 through 38.

Aspect 53: A first AP comprising a processing system that includes processor circuitry and memory circuitry that stores code, the processing system configured to cause the first AP to perform a method of any of aspects 39 through 43.

Aspect 54: A first AP comprising at least one means for performing a method of any of aspects 39 through 43.

Aspect 55: A non-transitory computer-readable medium storing code the code comprising instructions executable by one or more processors to perform a method of any of aspects 39 through 43.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
one or more memories storing processor-executable code; and
one or more processors coupled with the one or more memories and individually or collectively operable to execute the code to cause the first AP to:
perform, during a first transmission opportunity, a first cross-basic service set (BSS) channel state information (CSI) collection procedure corresponding to at least a first station (STA) served by the first AP and a second AP, the first AP associated with a first BSS and the second AP associated with a second BSS;
perform, during the first transmission opportunity and after the first cross-BSS CSI collection procedure, an in-BSS CSI collection procedure corresponding to at least the first STA served by the first AP; and
perform, during the first transmission opportunity or during a second transmission opportunity in accordance with information exchanged via a first initial handshake procedure between the first AP and the second AP, a second cross-BSS CSI collection procedure corresponding to at least a second STA served by the second AP.

2. The first AP of claim 1, wherein the one or more processors are individually or collectively further operable to execute the code to cause the first AP to:
detect a failure of the in-BSS CSI collection procedure; and
reinitiate the in-BSS CSI collection procedure based at least in part on the detecting.

3. The first AP of claim 1, wherein the one or more processors are individually or collectively further operable to execute the code to cause the first AP to:
refrain from performing a second initial handshake procedure with the second AP after detecting a failure of the in-BSS CSI collection procedure and prior to reinitiating the in-BSS CSI collection procedure.

4. The first AP of claim 1, wherein, to perform the first cross-BSS CSI collection procedure, the one or more processors are individually or collectively operable to execute the code to cause the first AP to:
perform the first initial handshake procedure with the second AP and a second handshake procedure with the first STA;
transmit a null data packet announcement (NDPA) frame that triggers a null data packet (NDP) frame by the second AP;
transmit, after the NDP frame is transmitted by the second AP, a beamforming report poll (BFRP) frame; and
receive a CSI report message from the first STA in accordance with the BFRP frame.

5. The first AP of claim 1, wherein, to perform the in-BSS CSI collection procedure, the one or more processors are individually or collectively operable to execute the code to cause the first AP to:
transmit, in accordance with a previous handshake procedure with the first STA before the first cross-BSS CSI collection procedure, a null data packet announcement (NDPA) frame that indicates a null data packet (NDP) frame;
transmit the NDP frame;
transmit a beamforming report poll (BFRP) frame; and
receive a CSI report message from the first STA in accordance with the BFRP frame.

6. The first AP of claim 1, wherein, to perform the second cross-BSS CSI collection procedure, the one or more processors are individually or collectively operable to execute the code to cause the first AP to:
perform the first initial handshake procedure with the second AP;
detect a null data packet announcement (NDPA) frame from the second AP that triggers a null data packet (NDP) frame by the first AP;
transmit the NDP frame in accordance with the NDPA frame; and
receive a CSI report message from the second STA in accordance with the NDP frame.

7. The first AP of claim 1, wherein the one or more processors are individually or collectively further operable to execute the code to cause the first AP to:
perform, during the second transmission opportunity based at least in part on failure of at least one of the first cross-BSS CSI collection procedure, the in-BSS CSI collection procedure, and the second cross-BSS CSI collection procedure, a repetition of the first cross-BSS CSI collection procedure, the in-BSS CSI collection procedure, and the second cross-BSS CSI collection procedure, a repetition of only the first cross-BSS CSI collection procedure and the in-BSS CSI collection procedure, or a repetition of only the second cross-BSS CSI collection procedure.

8. The first AP of claim 7, wherein the repetition of only the first cross-BSS CSI collection procedure and the in-BSS CSI collection procedure is performed during the second transmission opportunity based at least in part on failure of at least one of the first cross-BSS CSI collection procedure and the in-BSS CSI collection procedure during the first transmission opportunity.

9. The first AP of claim 7, wherein the repetition of only the second cross-BSS CSI collection procedure is performed during the second transmission opportunity based at least in part on the failure of the second cross-BSS CSI collection procedure during the first transmission opportunity.

10. The first AP of claim 1, wherein the one or more processors are individually or collectively further operable to execute the code to cause the first AP to:
perform, after the second cross-BSS CSI collection procedure, a second in-BSS CSI collection procedure corresponding to at least the second STA served by the second AP.

11. A first access point (AP), comprising:
one or more memories storing processor-executable code; and
one or more processors coupled with the one or more memories and individually or collectively operable to execute the code to cause the first AP to:
perform, during a first transmission opportunity, a first cross-basic service set (BSS) channel state information (CSI) collection procedure corresponding to at least a first station (STA) served by the first AP and a second AP, the first AP associated with a first BSS and the second AP associated with a second BSS;
perform, during the first transmission opportunity, a second cross-BSS CSI collection procedure corresponding to at least a second STA served by the second AP; and
perform, during a second transmission opportunity, an in-BSS CSI collection procedure corresponding to at least the first STA.

12. The first AP of claim 11, wherein, to perform the first cross-BSS CSI collection procedure, the one or more processors are individually or collectively operable to execute the code to cause the first AP to:
perform a first handshake procedure with the second AP and a second handshake procedure with the first STA;
transmit a null data packet announcement (NDPA) frame that triggers a null data packet (NDP) frame by the second AP;
transmit, after the NDP frame is transmitted by the second AP, a beamforming report poll (BFRP) frame; and
receive a CSI report message from the first STA in accordance with the BFRP frame.

13. The first AP of claim 11, wherein, to perform the second cross-BSS CSI collection procedure, the one or more processors are individually or collectively operable to execute the code to cause the first AP to:
detect, in accordance with a previous handshake procedure with the second AP, a null data packet announcement (NDPA) frame from the second AP that triggers a null data packet (NDP) frame by the first AP;
transmit the NDP frame in accordance with the NDPA frame; and
receive a CSI report message from the second STA in response to a beamforming report poll (BFRP) frame from the second AP and in accordance with the NDP frame.

14. The first AP of claim 11, wherein, to perform the in-BSS CSI collection procedure, the one or more processors are individually or collectively operable to execute the code to cause the first AP to:
perform a handshake procedure with the first STA;
transmit a null data packet announcement (NDPA) frame that indicates a null data packet (NDP) frame;
transmit the NDP frame in accordance with the NDPA frame;
transmit a beamforming report poll (BFRP) frame in accordance with the NDP frame; and
receive a CSI report message from the first STA in accordance with the BFRP frame.

15. A first access point (AP), comprising:
one or more memories storing processor-executable code; and
one or more processors coupled with the one or more memories and individually or collectively operable to execute the code to cause the first AP to:
perform, during a first transmission opportunity, a first cross-basic service set (BSS) channel state information (CSI) collection procedure corresponding to at least a first station (STA) served by the first AP and a second AP, the first AP associated with a first BSS and the second AP associated with a second BSS, wherein the first cross-BSS CSI collection procedure comprises a plurality of CSI portions; and
receive, from the second AP, at least one feedback message based at least in part on the first cross-BSS CSI collection procedure.

16. The first AP of claim 15, wherein the at least one feedback message comprises a single feedback message associated with the plurality of CSI portions, the single feedback message received after completion of the plurality of CSI portions.

17. The first AP of claim 15, wherein the at least one feedback message comprises a respective feedback message associated with each CSI portion of the plurality of CSI portions, each feedback message received after a corresponding CSI portion.

18. The first AP of claim 15, wherein the at least one feedback message is received during the first transmission opportunity.

19. The first AP of claim 15, wherein the at least one feedback message comprises a single feedback message received during a second transmission opportunity subsequent to the first transmission opportunity.

20. The first AP of claim 15, wherein the one or more processors are individually or collectively further operable to execute the code to cause the first AP to:
transmit a first CSI confirm frame indicating successful reception when each CSI portion of the plurality of CSI portions is successfully received, wherein the first CSI confirm frame is transmitted during the first transmission opportunity or during a second transmission opportunity later than the first transmission opportunity; and
transmit a second CSI confirm frame indicating unsuccessful reception when at least one CSI portion of the plurality of CSI portions is unsuccessfully received, the second CSI confirm frame requesting retransmission of at least one CSI portion of the plurality of CSI portions, wherein the second CSI confirm frame is transmitted during the first transmission opportunity or during a second transmission opportunity later than the first transmission opportunity.
